(19) United States
(12) Patent Application Publication
(10) Pub. No.: US 2009/0313365 A1
(43) Pub. Date: Dec. 17, 2009

(54) DATA PROCESSING

(76) Inventor: Stephen Whitehead, Cheshire (GB)

Correspondence Address: BARNES & THORNBURG LLP, P.O. BOX 2786, CHICAGO, IL, 60690-2786, US

(21) Appl. No.: 12/307,862

(22) PCT Filed: Jul. 9, 2007
(86) PCT No.: PCT/GB07/50386

§ 371 Date: Jan. 7, 2009

(30) Foreign Application Priority Data
Jul. 7, 2006 (GB) 0613502.4

(51) Int. Cl. G06F 3/147

(52) U.S. Cl. 709/223

(57) ABSTRACT

A central management system exchanges data with a store at a remote site, where a display imparts visible and/or audible information to store customers. Monitoring means at the store monitors behavior of store customers. Predetermined content data is transmitted from the central management system to the remote store site for display. Monitored customer behaviour data is transmitted from the remote store site to the central management system, to enable evaluation of the customer behaviour in response to the content data. Data transmission between the central management system and the remote store site is effected without using the in-store IT system. Stock may be monitored at a Point of Purchase (POP) display. Barcode readers may be monitored passively. Brand means may impart visible or audible information to store customers or operatives. Compliance means may monitor whether a poster is displayed at a POP.

The present invention relates to data processing and is concerned particularly with the processing of data relating to store transactions.

In the context of this specification, the term “store” means a place where customers view and purchase goods and/or services. Preferred embodiments of the invention are concerned with retail stores, but other embodiments of the invention may be applied to wholesale stores.

In a retail store, timely and effective communication of goods information is essential for retailers, brand owners and consumers. Communication is often achieved with paper-based Point of Purchase (POP) material dispatched from central locations to retail stores, which conveys information about products, such as advertising, promotions and marketing information. Sending out paper-based POP material is a slow process, where marketing information on displays needs to be known in advance of a promotional period. Furthermore, it is difficult to change the information quickly, especially as a result of consumer response.

There is often a reliance on a retailer to display received POP material in-store. Problems may occur with retailer compliance, whereby POP material is not displayed in line with a brand owner's needs. This results in poor communication to the consumer, such that brand owners find it difficult to determine the effectiveness of promotional events. This problem is not restricted to brand owners and retailers, but also includes compliance of retailer stores with the retailer's own head office and between franchisees and franchisors, etc.

To overcome these problems, digital signage solutions, such as in-store video displays, have been used, where content can be dynamically updated from a PC or server in-store via a local network, or remotely from a central location. Although information can then be distributed and updated rapidly, problems lie with understanding the consumer's response to the delivered information or “content”. Such responses include purchasing goods, responding to instructions or warnings, or perhaps not responding to the information at all.

POP displays are often used for marketing specific brands; these are often supplied to retailers free of charge by brand owners. Due to the “hard” nature of this media, displayed POP material cannot be updated frequently, and there is no provision for knowing the status of stock on the POP display without physically visiting it.

“POP display” is a broad term covering any POP structure designed to dispense or present specific brands or types of products for purchase, where promotional or marketing information is included on the structure. Traditional POP displays are mechanical structures, built from any material such as cardboard, plastic, metal, etc. and are typically used in retail for products such as newspapers, magazines, razor blades, tobacco products, CDs, PC games, Mobile phones, DVDs, PC software, etc.

Monitoring the response to promotions is typically slow. Any goods purchased are typically taken from a shelf or POP display and taken to an in-store payment terminal. Payments are processed through the retailer's business and Information Technology (IT) infrastructure, which imposes a reliance on the retailer's systems. Delivering information from a retailer's system to the brand or merchandise owner's system is therefore a slow process and in some stores is not available to the brand or merchandise owner. This results in an inability to update displayed POP material quickly in response to consumer response.

Alternatively, clipboard marketing exercises are often conducted at selected stores, with consumer interviews and questionnaires. Paper-based monitoring is slow and subject to human error.

It is known that flashing displays or moving messages influence consumer purchase decisions. However, without rapid feedback and monitoring of consumer response, it is difficult to determine the most effective method that influences purchasing decision and generates customer awareness. An ability to achieve this quickly would enable effective marketing campaigns to be produced, which maximise sales revenues.

Although digital signage is currently used in-store, displays showing information about specific brands or goods are often located at positions away from the goods themselves. Furthermore, in-store digital signage often displays information about more than one product or brand.

Accent lighting is often used in a retail environment to draw the consumer's attention to specific brands or products. This can take the form of different lighting levels and lighting colours on shelves, POP displays or areas of the store using different types of lighting sources such as LED, fluorescent, incandescent, sodium, halogen sources, etc.

Brand owners and merchants often sell their products as concessions through other retail outlets, utilising the retailer's store and business systems. Brand owners and merchants are often responsible for restocking products in the retailer outlet. Slow access to stock levels and purchasing information of concessioned goods may result in overstock or understock of products in the retail stock. This results in cash tied up in stock or lost sales and an inefficient supply chain. Overstocked less popular items are often sold through “discount sales”, which reduce potential revenues.

This places a burden, whereby stock is counted on a regular basis in both a backroom store and shop display to ensure that there is no shortage of stock, colours or sizes that may hinder stock sales. This information provides a manual indication of stock status, which is used for replenishment.

In some cases, in-store POP displays are replenished by third parties who obtain no or slow stock status information which is then passed on to the brand owner or merchant, resulting in the same understock, overstock or supply-chain inefficiency problems.

Similar problems exist for magazines, newspapers and other short shelf-life or perishable products, where the responsibility for crediting or disposing of unsold products lies with the supplier. As an example, publishers will ship magazines based on a retailer's forecast. However the publisher will credit the retailer for any unsold products. In this case, the publisher is dependent upon the retailer's forecast, which often results in over-stock, high levels of waste and associated disposal charges.

“Product recalls” as a result of manufacturing problems, contamination or food terrorism, etc. are currently undertaken by a manual process, whereby notices are sent to retailers and published in magazines to advise removal of specific products and/or product batches from shelves and from sale. Furthermore, there is a slow or non-existent process of compliance, where there are difficulties in knowing if retailers have complied. As a result, where there is no compliance, perhaps due to delays, retailers may inadvertently threaten the health and safety of their customers, leading to legal and insurance claims. The time between first notification and known compliance is critical, as is the time between retailers receiving a product recall and removing products from shelves, since customers may have already picked a recalled product from a shelf.

WO 03098519 discloses a method and apparatus for display and collection of information. This describes displaying product information to a user on a display device and a user entering parameters to help product selection prior to purchase, related to the wine and spirit industry. In this, the user or consumer directly influences and controls the display content based on monitored input parameters.

JP 2003058948 describes an electronic price labelling system that includes an electronic sign delivering product pricing or advertising information. The communication elements reside in-store and utilise the retailer's network.

GR 1003631 describes advertising in-store media controlled from a central location and is primarily concerned with computer and TV screens for advertising presentation.

U.S. Pat. No. 6,502,076 describes a network of retail self-service terminals with touch screen displays. Information is provided about in-store items such as store locations and products together with advertising. “Attract loops” are included to cycle “content” which attracts consumers to the terminal. The terminal monitors user activity such as the number of interactions with the terminal, customer choices, etc.

U.S. Pat. No. 5,243,504 describes a system and method for increasing the sales of goods on a shelf by flashing a light such as an LED to attract customer attention.

WO 02098183 describes the control of lighting sources for space-illumination in different environments including retail, including automated changes in response to local sensors as a means of feedback.

US 2005/095573 describes a system and method for remotely monitoring the presence of POP displays in a retail store. It achieves this by embedding a Radio Frequency Identification (RFID) tag within the POP display which communicates with an RFID reader external to the POP display, which in turn communicates with an in-store communication device, which then communicates with a central database management system.

There are many known references to RFID, such as US 2005/040934, US 2005/134461 and many others. Most prior art in this area resides around monitoring the presence of an asset and notifying management systems or other devices. There are references to electronic displays used in conjunction with RFID; however these are largely used for displaying information detected in relation to the RFID tag or related product.

Preferred embodiments of the present invention aim to provide data processing systems and methods that provide users at a central management system with a way to provide display content of improved relevance at a remote store.

According to one aspect of the present invention, there is provided a data processing system comprising:

a central management system;

a store at a site that is remote from the location of the central management system;

communication means for providing data communication between said central management system and remote site;

display means at said remote site arranged to display content that imparts visible and/or audible information to store customers; and

monitoring means at said remote site arranged to monitor behaviour of store customers:

wherein said data processing system is arranged to transmit predetermined content data from said central management system to said remote site for display on said display means and to transmit from said remote site to said central management system monitored customer behaviour data, to enable evaluation at said central management system of said customer behaviour in response to said content data.

Preferably, said display means comprises a display for displaying visible content.

Said display means may comprise lighting means, the operation of which is varied in dependence upon content data received from said central management system.

Preferably, said display means is located in the vicinity of a display of respective goods to which said content data received from said central management system relates.

Said display means may be adjacent to or integrated with a Point Of Purchase (POP) display.

Preferably, said monitoring means is adapted to receive product purchase information at a payment terminal.

Preferably, said monitoring means is adapted to receive product barcode information at a payment terminal.

Preferably, said monitoring means is adapted to receive said product barcode information passively during a sales transaction at a payment terminal.

Said monitoring means may be adapted to receive product RFID information at a payment terminal.

Said monitoring means may be adapted to detect movement of stock on or from a display point.

Said monitoring means may be adapted to detect change of weight of stock at a display point.

A data processing system as above is preferably arranged to transmit said predetermined content data from said central management system to said remote site and to transmit said monitored customer behaviour data from said remote site to said central management system, without reliance upon existing in-store IT infrastructure at said remote site.

A data processing system as above is preferably arranged to share infrastructure with systems for other data processing or control functions at said remote site.

A data processing system as above may further comprise:

a central management system;

a store at a site that is remote from the location of the central management system;

communication means for providing data communication between said central management system and remote site;

a Point Of Purchase (POP) display at said remote site; and

stock monitoring means at said remote site arranged to monitor the level of stock in said POP display:

wherein said data processing system is arranged to transmit stock level data monitored by said stock monitoring means to said central management system by said communication means.

Said stock monitoring means may be adapted to detect movement of stock on said POP display.

Said stock monitoring means may be adapted to detect change of weight of stock on said POP display.

A data processing system as above may further comprise means for detecting and transmitting to said central management system further data representing at least one of: the presence and/or movement of consumers in the vicinity of said POP display; ambient conditions in the vicinity of said POP display; and local promotion information in the vicinity of said POP display such as electronic displays and posters.

Said ambient conditions may comprise temperature and/or lighting conditions.

Said local promotion information may comprise poster and/or electronic displays.

Preferably, said POP display is not adapted to take payment for products displayed or dispensed.

A data processing system as above is preferably arranged to transmit said stock level data monitored by said stock monitoring means from said remote site to said central management system, without reliance upon existing in-store IT infrastructure at said remote site.

A data processing system as above is preferably arranged to share infrastructure with systems for other data processing or control functions at said remote site.

A data processing system as above may further comprise:

a central management system;

a store at a site that is remote from the location of the central management system;

communication means for providing data communication between said central management system and remote site;

a payment terminal in said store;

a barcode reader at said payment terminal; and

passive monitoring means arranged to monitor passively barcode data read by said barcode reader without modifying the barcode data:

wherein said data processing system is arranged to transmit barcode data monitored by said passive monitoring means to said central management system by said communication means.

Preferably, said passive monitoring means is arranged to monitor barcode data only for a predetermined range of products.

A data processing system as above may further comprise a hand-held barcode reader device for scanning stock on display or held at said remote site ready for display: wherein said data processing system is arranged to transmit barcode data monitored by said hand-held barcode reader device to said central management system by said communication means.

A data processing system as above may comprise a plurality of said passive monitoring means.

Preferably, said central management system is arranged to monitor stock levels in response to barcode data received from said passive monitoring means.

A data processing system as above is preferably arranged to transmit said barcode data monitored by said passive monitoring means from said remote site to said central management system, without reliance upon existing in-store IT infrastructure at said remote site.

A data processing system as above is preferably arranged to share infrastructure with systems for other data processing or control functions at said remote site.

A data processing system as above may further comprise:

brand alarm means at said remote site arranged to impart visible and/or audible information to store customers and/or operatives;

wherein said data processing system is arranged to transmit brand alarm data from said central management system to said brand alarm means such that said brand alarm means is operative to impart visible and/or audible brand alarm information to store customers and/or operatives, which information is configured in response to said brand alarm data transmitted from said central management system.

Preferably, said brand alarm means comprises a display means arranged to display visible content.

Preferably, said brand alarm means comprises acknowledgement means arranged to be activated by a store operative at said remote site to generate acknowledgement data indicating acknowledgement of brand alarm data received, and said data processing system is arranged to transmit said acknowledgement data to said central management system.

Preferably, said brand alarm means is adapted to receive product purchase information at a payment terminal and to impart visible and/or audible information to a store operative at said payment terminal in the event that said product purchase information indicates that a product being purchased falls within parameters defined by said brand alarm data.

Preferably, said brand alarm means is adapted to receive product barcode information at a payment terminal.

Preferably, said brand alarm means is adapted to receive said product barcode information passively during a sales transaction at a payment terminal.

Said brand alarm means may be adapted to receive product RFID information at a payment terminal.

A data processing system as above is preferably arranged to transmit said brand alarm data from said central management system to said remote site and to transmit any related response data from said remote site to said central management system, without reliance upon existing in-store IT infrastructure at said remote site.

A data processing system as above is preferably arranged to share infrastructure with systems for other data processing or control functions at said remote site.

A data processing system as above may further comprise:

a Point Of Purchase (POP) poster display means at said remote site arranged to display a poster that imparts visible information to store customers; and

compliance monitoring means at said POP poster display means, arranged to monitor the presence of a poster at said POP poster display means and to output corresponding monitored compliance data:

wherein said data processing system is arranged to transmit from said remote site to said central management system monitored compliance data, to enable evaluation at said central management system of compliance with said predetermined poster compliance data.

Preferably, said POP poster display means comprises a poster holder and said compliance monitoring means is arranged to detect the presence of a poster in said holder.

Preferably, said compliance monitoring means is adapted to monitor barcode information provided on a poster, thereby to identify the properties of the poster.

Preferably, said compliance monitoring means comprises at least one infra-red emitter and detector pair, adapted to detect black and white areas on a poster, in dependence upon infra-red reflections from the poster surface.

A plurality of such infra-red emitter and detector pairs may be adapted to detect black and white areas on a poster, arranged in a simple barcode format of less than 10 bars.

Preferably, said data processing system is arranged to transmit predetermined poster compliance data from said central management system to said compliance monitoring means and to transmit from said remote site to said central management system monitored compliance data, to enable evaluation at said central management system of compliance with said predetermined poster compliance data.

A data processing system as above is preferably arranged to transmit said predetermined poster compliance data from said central management system to said remote site and/or to transmit said monitored compliance data from said remote site to said central management system, without reliance upon existing in-store IT infrastructure at said remote site.

A data processing system as above is preferably arranged to share infrastructure with systems for other data processing or control functions at said remote site.

The invention extends to a product dispensing machine provided with a data processing system according to any of the preceding aspects of the invention, wherein the product dispensing machine has a plurality of discrete dispensing sections, each arranged to dispense a respective product, wherein a respective said POP poster display means is associated with each of said dispensing sections to identify the product to be dispensed.

Preferably, said compliance monitoring means is arranged to output said monitored compliance data to a control means of the dispensing machine, which control means processes said monitored compliance data to identify which products are displayed as being in the respective dispensing sections.

A product dispensing machine as above may be a vending machine.

In another aspect, the invention provides a method of data processing, comprising the steps of:

transmitting predetermined content data over a communication link from a central management system to a store at a site that is remote from the location of the central management system;

displaying at said remote site content derived from said content data, to impart visible and/or audible information to store customers;

monitoring behaviour of store customers means at said remote site; and

transmitting monitored customer behaviour data from said remote site to said central management system over said communication link, to enable evaluation at said central management system of said customer behaviour in response to said content data.

Such a method may be carried out by a data processing system according to any of the preceding aspects of the invention.

Such a method may further comprise the steps of:

providing a communication link between a central management system and a store at a site that is remote from the location of the central management system;

monitoring the level of stock in a Point Of Purchase (POP) display at said remote site; and

transmitting stock level data monitored by said stock monitoring means to said central management system.

Such a method may be carried out by a data processing system according to any of the preceding aspects of the invention.

Such a method may further comprise the steps of:

providing a communication link between a central management system and a store at a site that is remote from the location of the central management system;

providing a barcode reader at a payment terminal in said store;

passively monitoring barcode data read by said barcode reader without modifying the barcode data; and

transmitting barcode data monitored by said passive monitoring means to said central management system by said communication link.

Such a method may be carried out by a data processing system according to any of the preceding aspects of the invention.

Such a method may further comprise the steps of:

transmitting brand alarm data over a communication link from a central management system to a store at a site that is remote from the location of the central management system; and

imparting visible and/or audible brand alarm information to store customers and/or operatives, which information is configured in response to said brand alarm data transmitted from said central management system.

Such a method may be carried out by a data processing system according to any of the preceding aspects of the invention.

Such a method may further comprise the steps of:

transmitting predetermined poster compliance data over a communication link from a central management system to a Point Of Purchase (POP) poster display means at a store site that is remote from the location of the central management system;

monitoring the presence of a poster at said POP poster display means and outputting corresponding monitored compliance data; and

transmitting said monitored compliance data from said remote site to said central management system, to enable evaluation at said central management system of compliance with said predetermined poster compliance data.

Such a method may be carried out by a data processing system or in a product dispensing machine according to any of the preceding aspects of the invention.

For a better understanding of the invention, and to show how embodiments of the same may be carried into effect, reference will now be made, by way of example, to the accompanying diagrammatic drawings, in which:

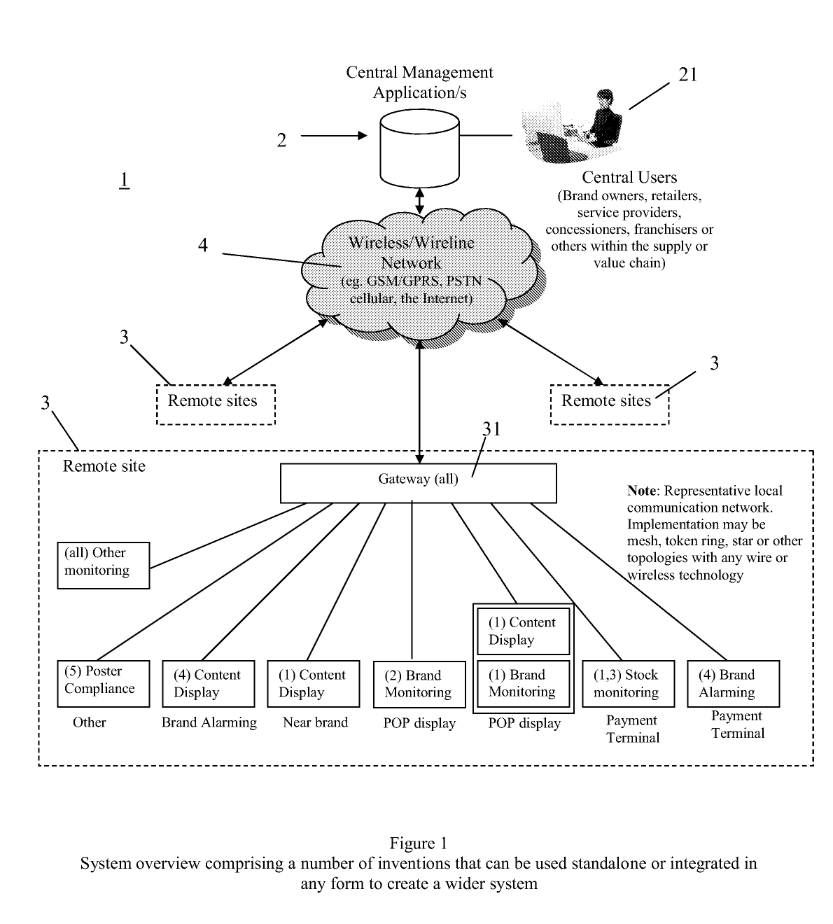

FIG. 1 is a general system overview illustrating the use of a number of different data processing systems in a retail store, to provide an exchange of data between the store and a remote, central management point;

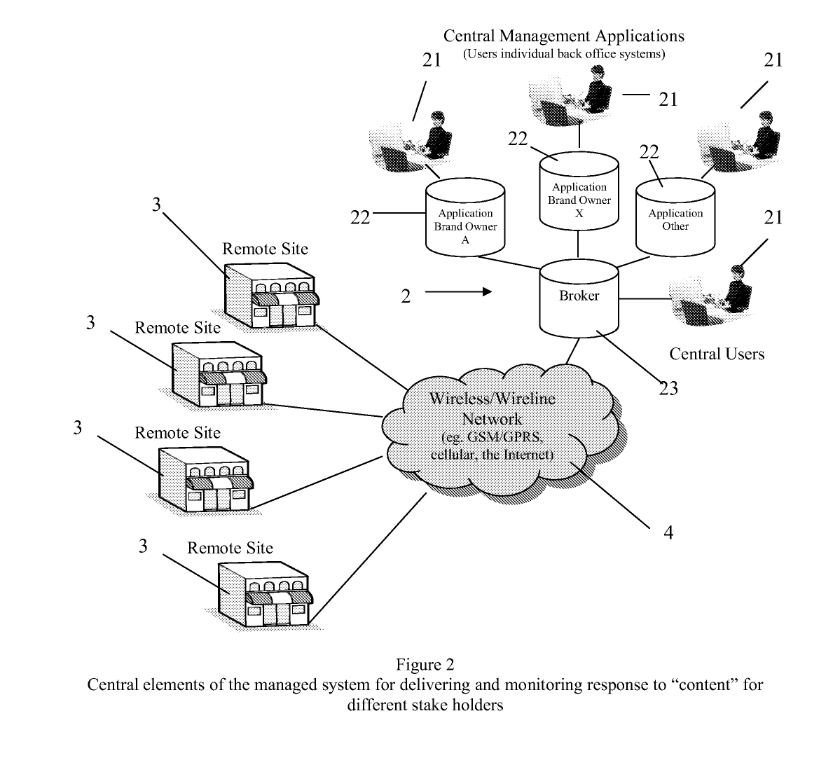

FIG. 2 illustrates central elements of a managed system for delivering and monitoring response to “content” for different stake holders;

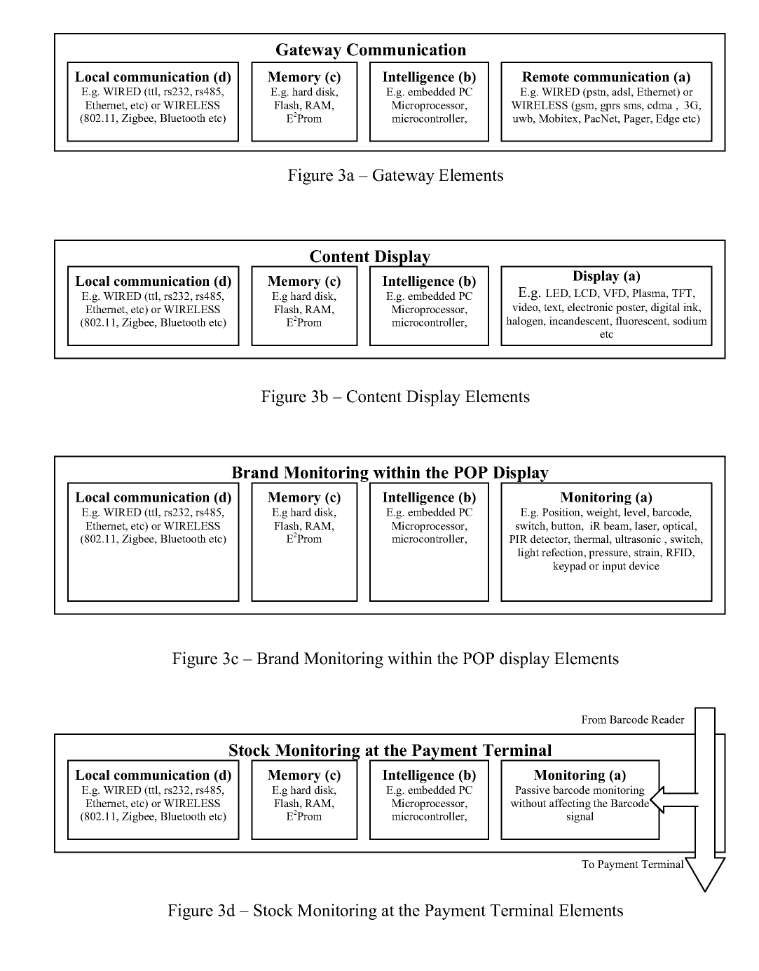

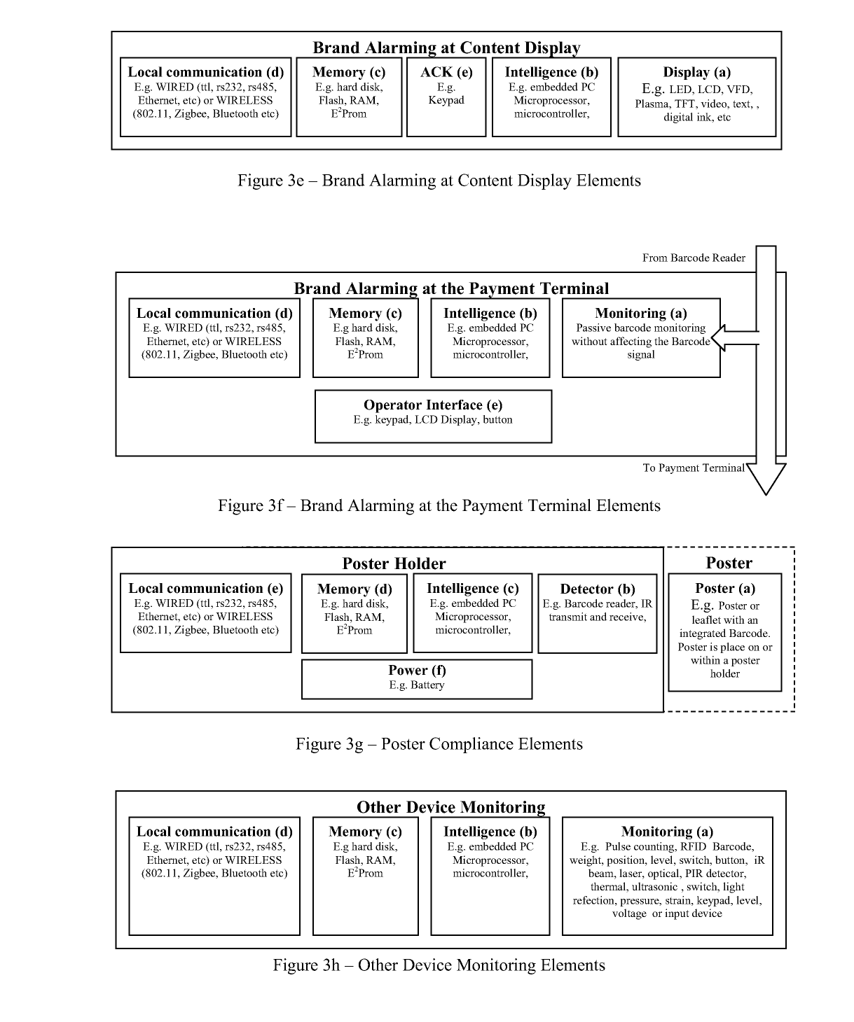

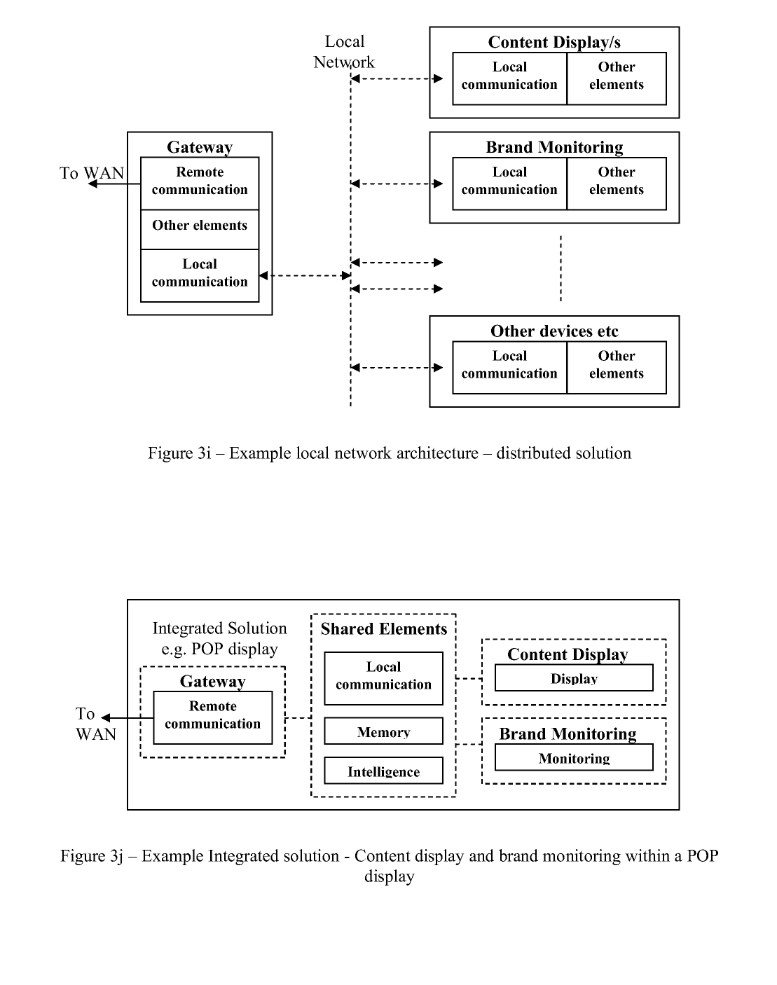

FIG. 3a illustrates gateway elements;

FIG. 3b illustrates content display elements;

FIG. 3c illustrates elements for brand monitoring within POP display;

FIG. 3d illustrates elements for stock monitoring at a payment terminal;

FIG. 3e illustrates elements for brand alarming at content display;

FIG. 3f illustrates elements for brand alarming at a payment terminal;

FIG. 3g illustrates poster compliance elements;

FIG. 3h illustrates other device monitoring elements;

FIG. 3i illustrates an example of a local network architecture, with a distributed solution;

FIG. 3j illustrates an example of an integrated solution for content display and brand monitoring within a POP display;

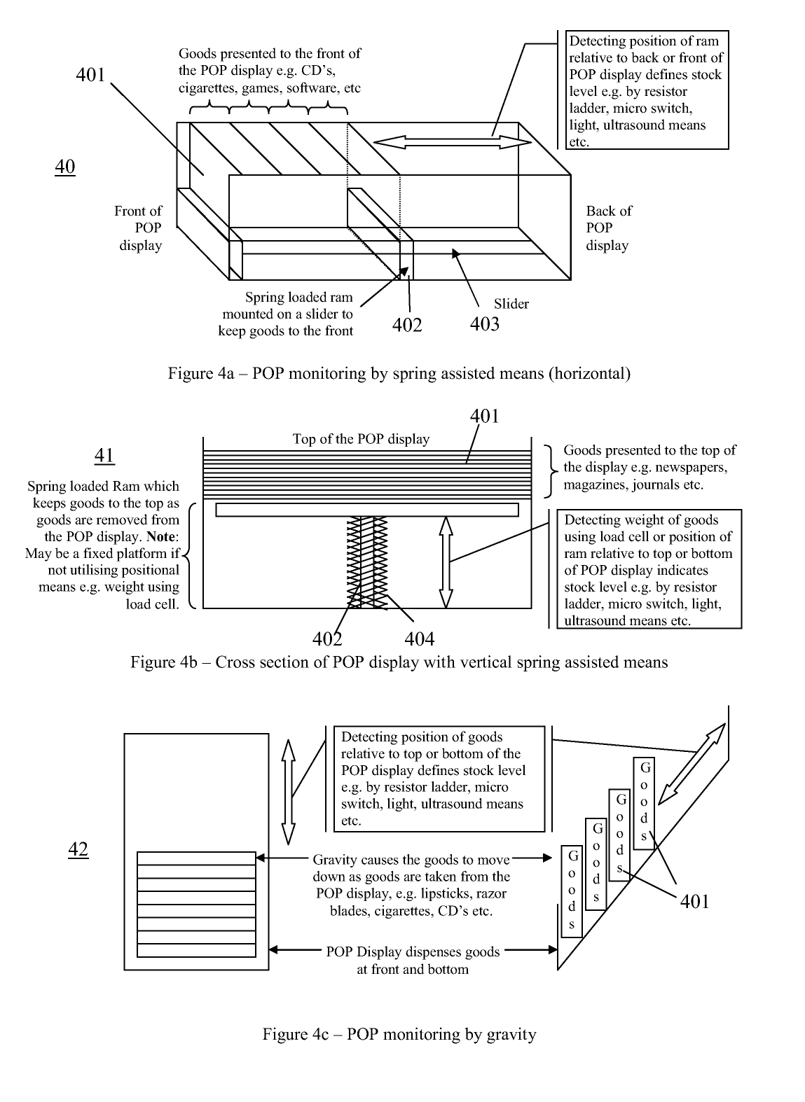

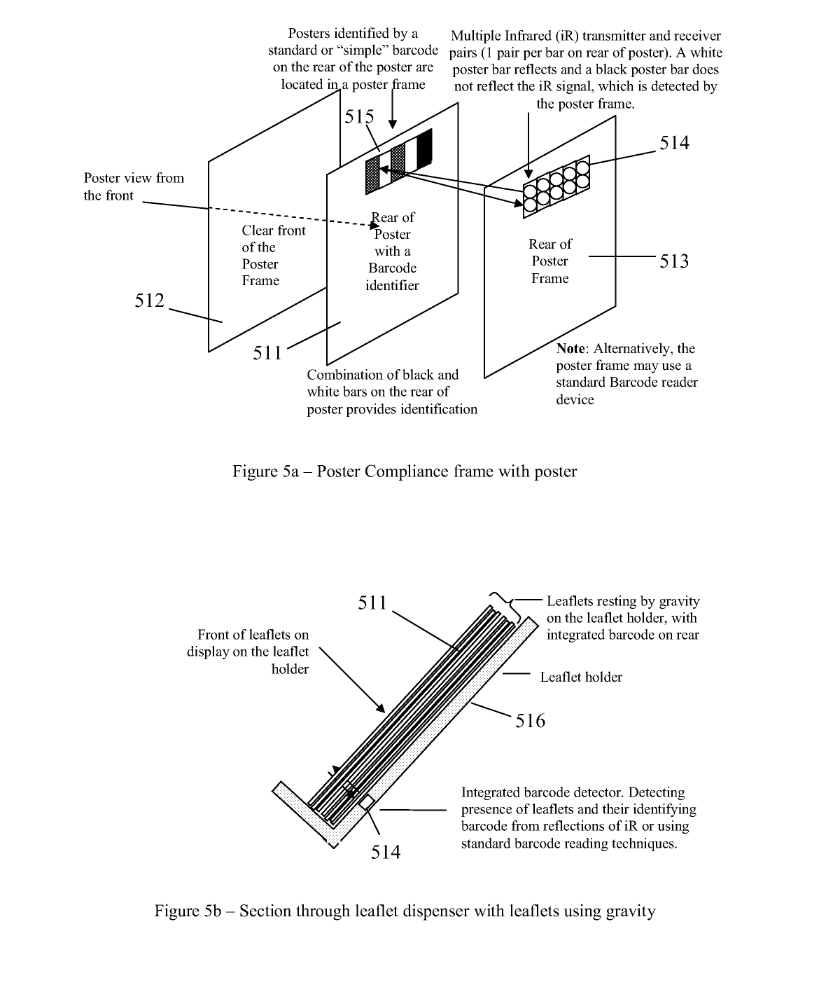

FIG. 4a illustrates POP monitoring by spring assisted means (horizontal);

FIG. 4b illustrates in cross-section a of POP display with vertical spring assisted means;

FIG. 4c illustrates POP monitoring by gravity;

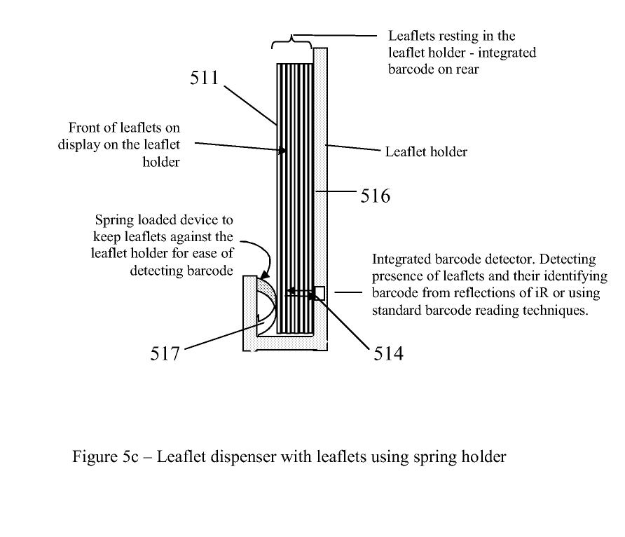

FIG. 5a illustrates a poster compliance frame with poster;

FIG. 5b illustrates in sectional view a leaflet dispenser with leaflets, using gravity;

FIG. 5c illustrates a leaflet dispenser with leaflets, using a spring holder;

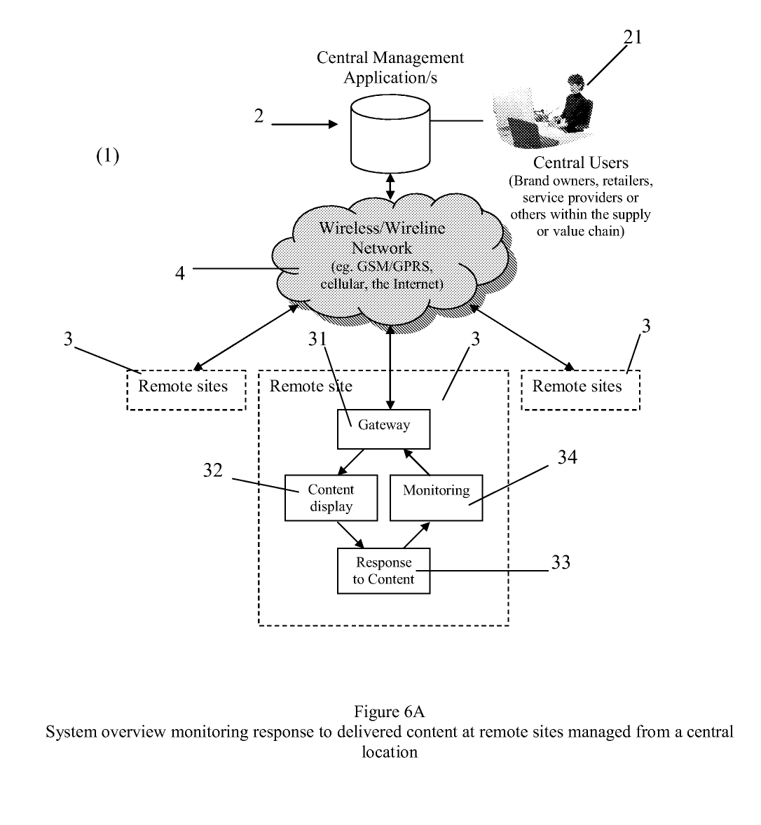

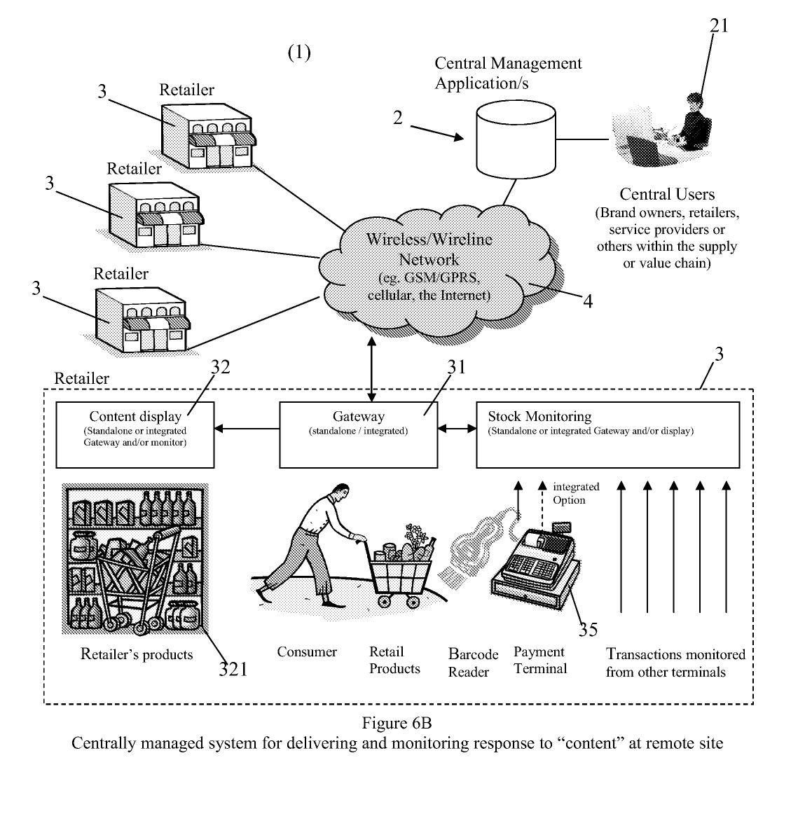

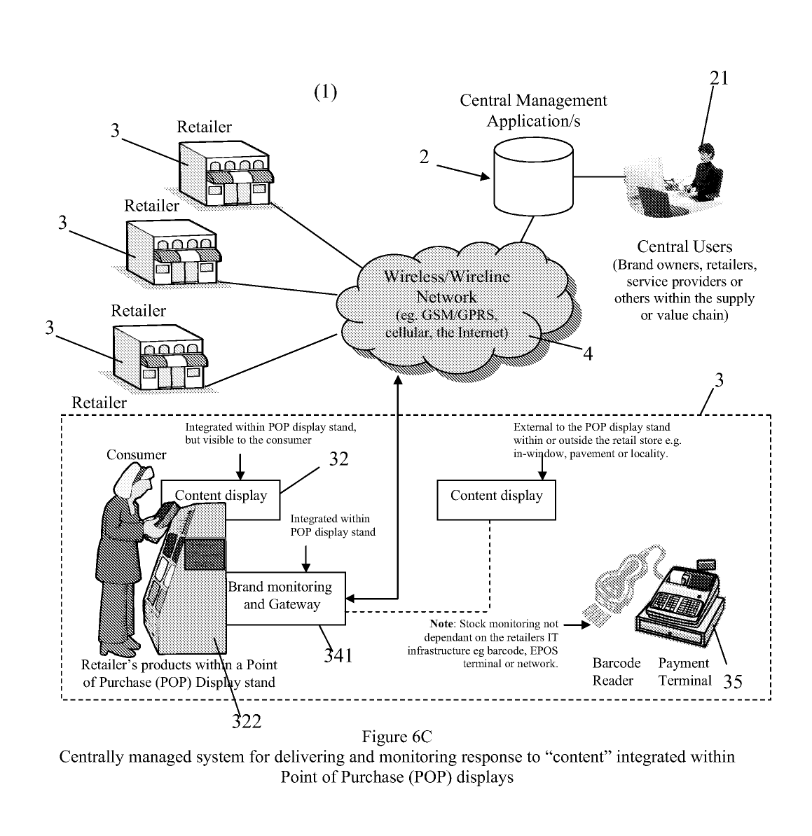

FIG. 6a is a system overview of a data processing system that monitors response to delivered content at remote sites managed from a central location;

FIG. 6b illustrates a centrally managed system for delivering and monitoring response to “content” at a remote site;

FIG. 6c illustrates a centrally managed system for delivering and monitoring response to “content” integrated within Point of Purchase (POP) displays;

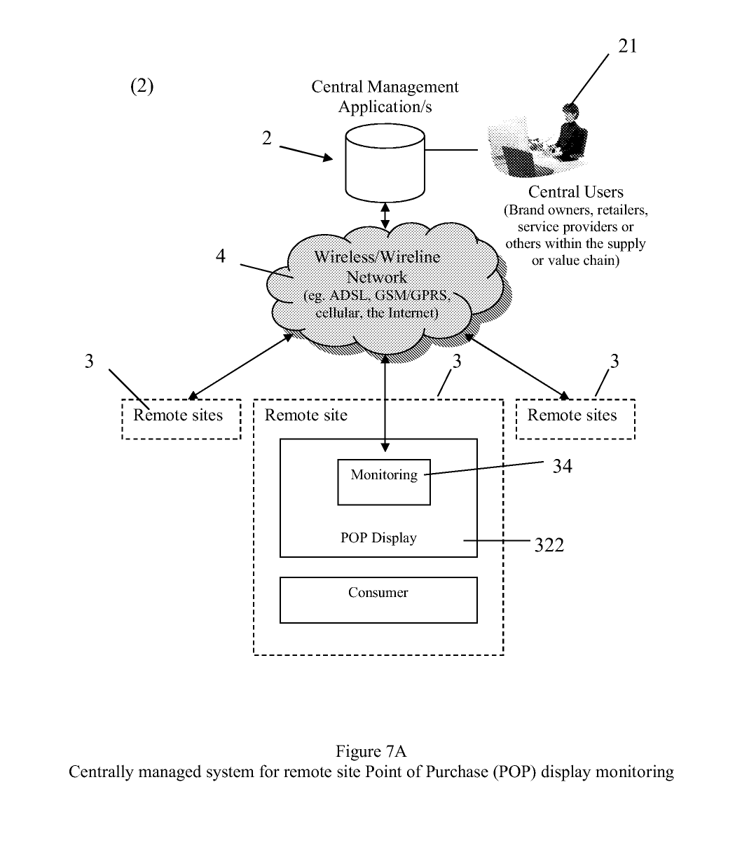

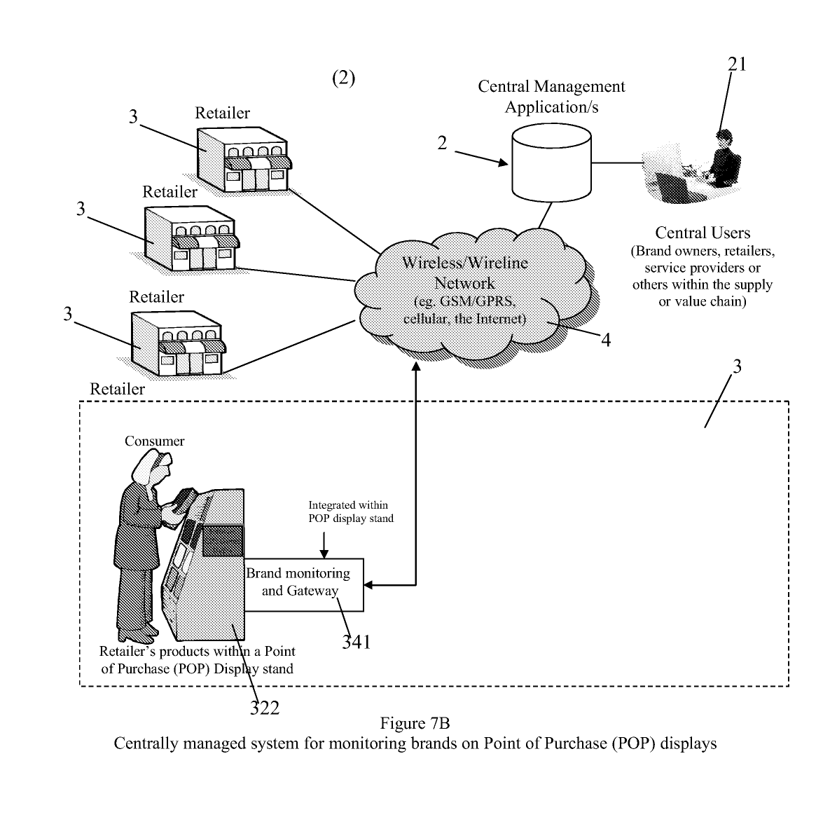

FIG. 7a illustrates a centrally managed system for remote site Point of Purchase (POP) display monitoring;

FIG. 7b illustrates a centrally managed system for monitoring brands on Point of Purchase (POP) displays;

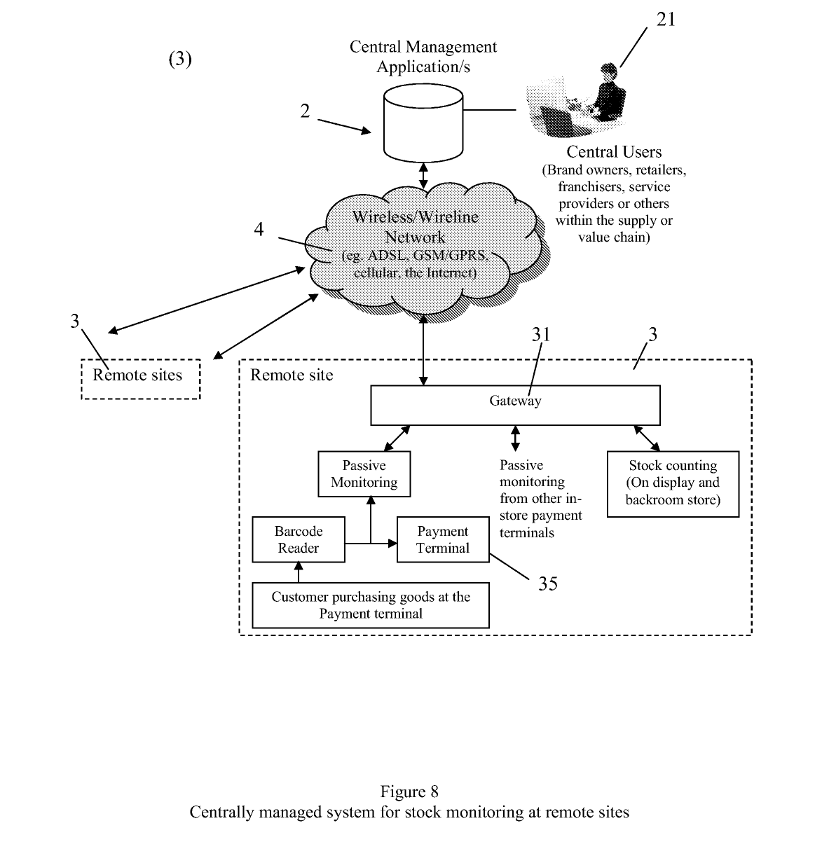

FIG. 8 illustrates a centrally managed system for stock monitoring at remote sites;

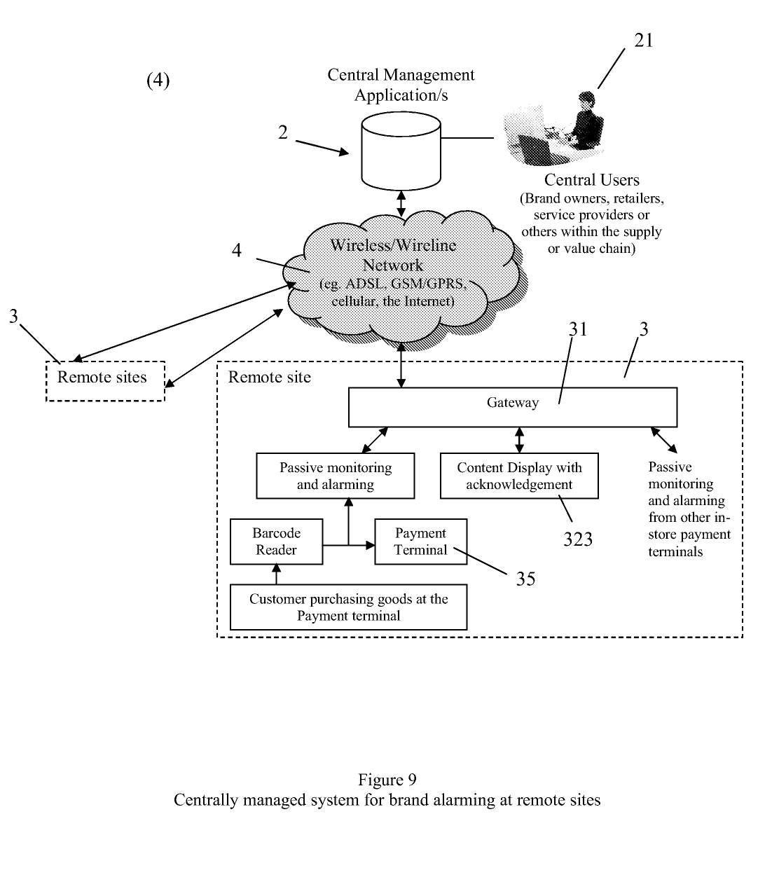

FIG. 9 illustrates a centrally managed system for brand alarming at remote sites;

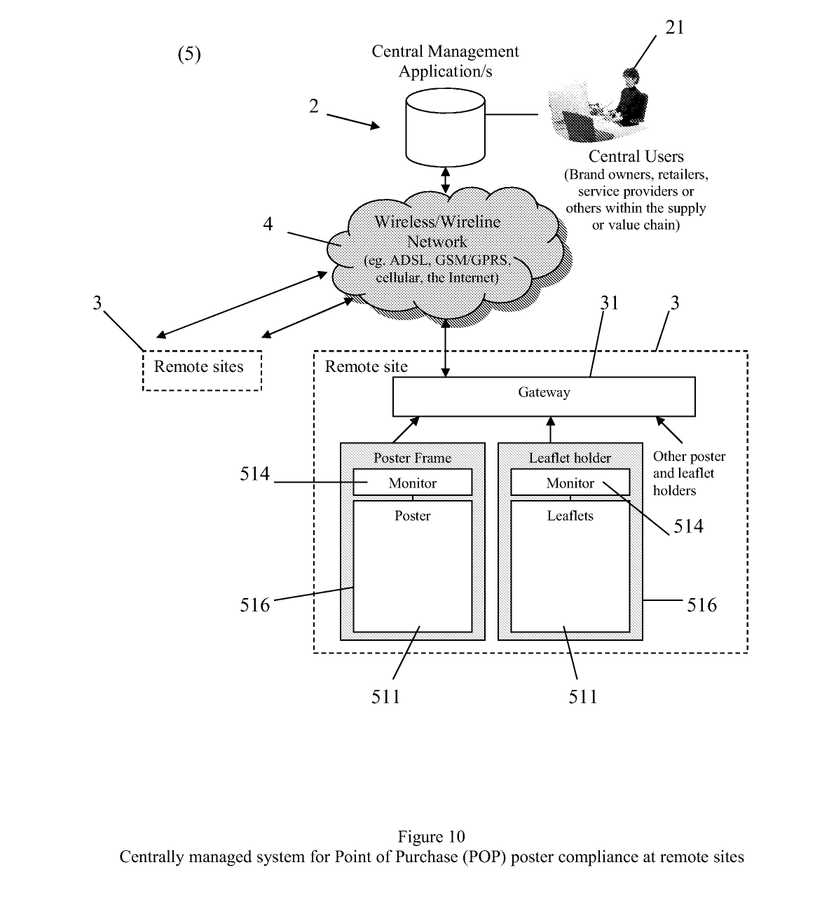

FIG. 10 illustrates a centrally managed system for Point of Purchase (POP) poster compliance at remote sites; and

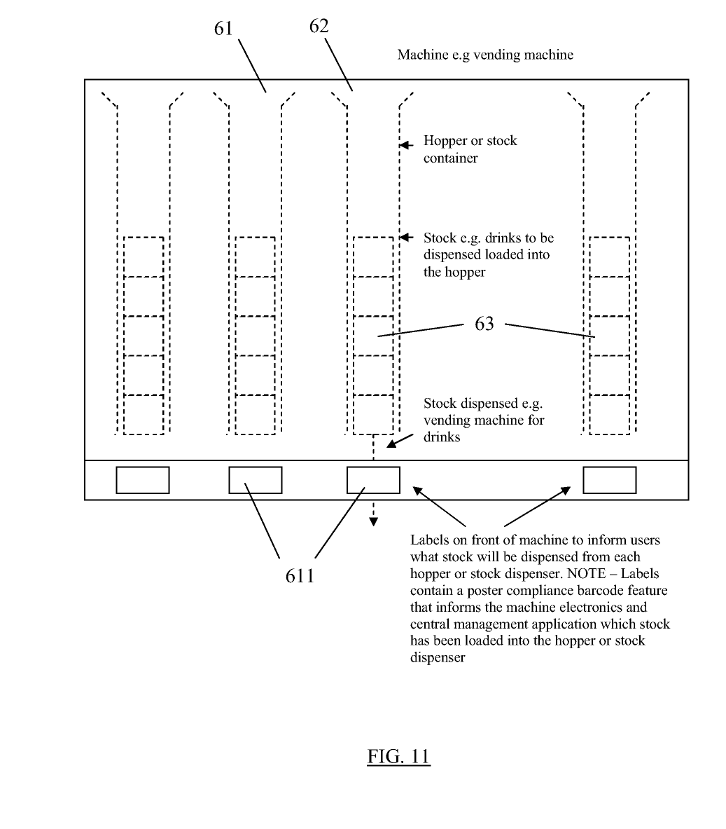

FIG. 11 illustrates a vending machine application in which the system of FIG. 10 has been adapted for further uses.

In the figures, like references denote like or corresponding parts.

FIG. 1 is an overview of a general system 1 that comprises a number of subsidiary data processing systems that can be used in standalone manner or integrated in any manner to create a wider system.

There are three basic elements common to each subsidiary system, namely:

a central management system or systems 2, which manage remote sites 3 over a Wide Area Network (WAN) 4, providing control, monitoring, management and service for central users 21;

the Wide Area Network 4, which provides connectivity between central and remote sites 2 and 3; and

the remote sites 3, where data is delivered to and/or data is monitored from devices within or around the remote site 3.

Each subsidiary system may be made up of separate discrete devices networked together at the remote site 3, or may be integrated into a single device. Furthermore, separate subsidiary systems at a remote site 3 may share common devices. As an example, a single gateway device 31 may enable a plurality of subsidiary systems at a remote site 3 to communicate over the WAN 4 to a plurality of central management applications.

In FIG. 1, subsidiary system (1) comprises a centrally managed system for delivering “content” and monitoring the response at a remote site payment terminal and POP display.

Subsidiary system (2) comprises a centrally managed system for remote site Point of Purchase (POP) display monitoring.

Subsidiary system (3) comprises a centrally managed system for stock monitoring at payment terminals of remote sites.

Subsidiary system (4) comprises a centrally managed system for brand alarming at remote sites at a content display and at a payment terminal.

Subsidiary system (5) comprises a centrally managed system for Point of Purchase (POP) poster compliance at remote sites

Since each subsidiary system creates an end-to-end infrastructure, this infrastructure can be used for monitoring other devices within the remote site such as utility meters, heating, refrigeration, air-conditioning, etc.

Each subsidiary system will therefore have the ability to be integrated to create a wider system, where it is easier to justify the business case for additional devices when the infrastructure is justified or shared with other systems.

Various terms as used in this description will now be explained, to aid understanding.

“Content” is a term used to describe information sent from a central management site to a remote site for visible display and/or audible announcement in some form to one or more people—e.g. consumers, shoppers, people in queues, etc.

Examples of content include pictures, images, text, video, sound, light-on, light-off, light-level, speech, music, etc.

Electronic content transmitted between a central and remote site will be translated into a visible or audible entity by a “content display”.

A “central management system” allows central users to control, monitor and manage a network of remote devices at remotes sites. FIG. 1 shows one or more central users such as brand owners, retailers, service providers, franchisers, concessionaires or others within a supply or value chain.

Central management systems may be dedicated systems for each subsidiary system, integrated management for multiple subsidiary systems or separate systems owned by individual central users.

FIG. 2 shows how a broker management system 23 can be used to route, buffer and consolidate data between remote sites 3 and central management systems 22 owned by individual users 21.

Central management systems 22 may be existing management systems such as those used for Supply Chain Management (SCM), Customer Relationship Management (CRM), etc.

Central users may be offered central management systems or broker management systems on a “software goods sales” basis or provided with access to these elements on a service basis which is paid on a monthly or on-going basis. As an example, a service operator my charge users for consolidated reports on activity at remote sites.

Central management systems are physically remote from the remote site—that is, they are not local management systems connected by a local network to the devices at the remote site.

A “Wide Area Network” or “WAN” enables central management applications to communicate with devices at remote sites over a wide area. That is, the central management system is not located in-store but is located at a physically separate site.

Examples of networks include the Internet, wireless WAN networks and wireline networks. Examples of wireless networks include GSM, GPRS, CDMA, EDGE, UMTS, Metropolitan Areas Networks (MAN) and cellular networks. Examples of wireline networks include PSTN, ADSL, Ethernet, etc.

Other examples of networks include one-way broadcast type networks such as UHF, VHF and satellite networks used for delivering information, where alternately wireless or wireline networks (as described) are used for control purposes for communicating back with the central site. These examples are not exhaustive and the term includes any network connecting central and remote sites.

The term “remote site” may typically refer to retailer stores such as supermarkets, grocery stores, convenience stores, mass merchandising outlets, newsagents, drug stores, specialty retail outlets (e.g., pet stores, record stores, book stores), consumer electronics stores, etc. A remote site includes any location where goods and services can be purchased such as retail stores (above), hospitality and leisure (pubs, hotels, cafes, etc.),

A remote site also includes any location where information can be delivered, such as railway station platforms, outside retail stores (e.g. kerb side), car parks, kiosks, through-ways, etc.

A remote site may include areas where there is a captive audience where information can be displayed—such as at bus stops, banks, post-offices and urinals.

A remote site may include areas where regulatory compliance is required, such as at the workplace, e.g. for health and safety compliance

A remote site is any location separated by distance from a central management location and which requires a wide area network for communication.

For clarity, any reference to in-store, retailer store, etc. is applicable to remote sites as described here.

There are numerous remote site elements, which can be standalone and/or integrated in whole or part.

The term “gateway” refers to a remote site device that interfaces local remote site devices (e.g. content displays, stock monitoring, brand alarming, etc.) with a WAN for communication with central management systems.

The gateway may be shared by multiple devices and subsidiary systems. Alternatively, a gateway may be dedicated for a specific subsidiary system, such that there may be one or more gateways at a remote site.

A gateway may be integrated with other devices, such as content displays or monitoring devices, and may share common resources such as processing and memory. Alternatively, it may be physically separate from other devices at a remote site and be networked to them by wired or wireless means.

FIG. 3a shows four potential elements of a gateway, depending on the level of integration with other devices.

(a) Remote communication—which provides a WAN communication interface to transport data between remote site and central management applications. One or more network interfaces may be supported such as: —

Wireline WAN-PSTN, ADSL, ETHERNET

Wireless WAN-GSM, GPRS, CDMA, 3G, Edge, Ultra Wide Band (UWB), Mobitex, PacNet, Pager, Reflex, etc.

(b) Intelligence—which provides processing intelligence for the gateway, managing data flow between local devices over the local communication interface, memory and remote communication with central management system.

Intelligence is implemented by a software or firmware program running on a microprocessor, microcontroller, embedded PC or other embedded processing device.

Routing—in it simplest form, it may provide routing of communication protocols through the gateway between the local and remote communication interfaces. In this case, the central management level communication protocols are integrated within the attached local device, e.g. content display, and the gateway simply routes data at the network level without interpreting the data. Standard available routers “off the shelf” can be used in this case.

Intelligent communication—in this mode of operation, the gateway has the intelligence to communicate, log and process data with both locally attached devices and central management applications.

(c) Memory—which provides storage for gateway information, buffering routed data, local device logged data, e.g. gateway configuration, stock transaction, local device configuration, e.g. display content, etc.

Memory may take varied forms such as RAM, Flash, EEprom, harddisk, etc.

(d) Local communication—which provides communication with other local devices at the remote site, such as content displays, brand alarming, poster compliance devices, etc. This can take the following forms:—

NONE—where the gateway is integrated with the local device itself.

WIRELINE—TTL, RS232, RS485, Ethernet, USB, Firewire, etc.

WIRELESS—802.11, Bluetooth, ZigBee, low power RF, etc.

The term “content display” refers to one or more element at a remote site that converts electronic “content” from a central site into a visible or audible form.

A content display attracts attention at or delivers information to the remote site—such as advertising, instructions or other information. Content displays can be traditional displays such as LED, Plasma, TFT, Video, etc. However “content display” is a term that also includes such elements as accent lighting sources such as LEDs, sodium, halogen lighting sources, etc. to provide emphasis on specific areas or create required ambiences at remote sites and particularly in retail stores.

A content display may be located near a retailer's or specific brand owner's products to help draw attention to the products, or it may be located anywhere at a remote site.

Content may be sent electronically from the central site to the remote site for storage and/or display at a content display. Alternatively, content may be stored within a content display (or other remote site device) and displayed in accordance with instructions received, as previously configured by the central site.

FIG. 3b shows four key elements of a content display (although other may be present), namely:

(a) Display—which is the element that is visible or audible to the consumer where content is delivered. This includes:

Traditional displays—LED, LCD, VFD, Plasma, video, Electronic Posters, Digital ink, CRT, etc.

Accent lighting—LED, incandescent, halogen, fluorescent, sodium, etc.

Audio—speakers, buzzers, sounders, etc.

(b) Intelligence—which provides processing intelligence for the content display, managing data flow between local devices e.g. by a gateway over a local communication interface, memory and display.

Intelligence may be implemented by a software or firmware program running on a microprocessor, microcontroller, embedded PC or other embedded processing device.

Intelligent communication—in this mode of operation, the content display has the intelligence to communicate, obtain, log and process data directly with central management applications, using a gateway as a routing function only for WAN connectivity.

Non-intelligent communication—in this mode, an attached gateway provides intelligent communication with a central management application, whereby the gateway subsequently delivers content to the content display for display.

(c) Memory—which is used for storing content, configuration and other information.

Memory may take varied forms such as RAM, Flash, EEprom, harddisk, etc.

(d) Local communication—which provides communication with the gateway and other local devices at a remote site, such as brand alarming, stock monitoring, poster compliance devices, etc. This can take the following forms:—

NONE—where the content display is integrated with another local device e.g. gateway;

WIRELINE—TTL, RS232, RS485, Ethernet, USB, Firewire, etc.

WIRELESS—802.11, Bluetooth, ZigBee, low power RF, etc.

The term “POP display” is a broad term covering any Point of Purchase (POP) structure designed to dispense or present specific brands or types of products for purchase, where promotional or marketing information may be included on the structure. Traditional POP displays are mechanical structures, built from any material such as cardboard, plastic, metal, etc.

“Brands” is a broad term covering any specific brands or types of products that can be displayed, dispensed or presented for purchase from a POP display or at a payment terminal, such as newspapers, magazines, razor blades, tobacco products, CDs, PC games, Mobile phones, DVDs, PC software, etc.

“Brand monitoring” is a term used to describe the detection of the status of brands at a given location, e.g. POP display or payment terminal, where the detected status can be automatically or manually communicated to a management or display entity such as a PC, Server, PDA, mobile phone, application, etc.

In the context of this specification, the term “brand monitoring” also refers to the status of other non-brand conditions in the locality of a POP display, such as temperature, presence of consumers at the POP Display, passing footfall, light levels, periods of time consumers are present or of inactivity, etc.

Particular attention is paid herein to brand monitoring within a POP display, and this can be combined with other subsidiary systems as disclosed herein.

Monitoring the status of brands within a POP display enables brand owners (and others) to determine trends of brands taken from the POP display or replenished, plan inventory re-stocking and logistics and determine the effectiveness of marketing campaigns—e.g. advertising at local content displays or advertising posters.

FIG. 3c shows four key elements of brand monitoring within a POP display (although others may be present), namely:

(a) Monitoring—which refers to apparatus and methods for brand monitoring as described above, including:

Horizontal POP monitoring—apparatus and method described further below;

Vertical POP monitoring—apparatus and method described further below;

Gravity POP monitoring—apparatus and method described further below;

Other brand monitoring means—detection of brands by means of position, weight, level, switch, barcode, optical, pressure, strain, ultrasonic or RFID, etc.

Local environment—detection of local environmental conditions such as temperature, light levels, etc.

Consumer interaction—detection of consumers and consumer activity at the POP display, such as presence (e.g. PIR (Passive Infra-Red) detection), footfall (people counting), breaking optical beams, pressing buttons or keypads at the POP stand, etc.

Related product purchases—If a consumer is detected at the POP display (e.g. by PIR beam as mentioned above) and removes a specific brand from the POP display, this will be monitored. However, related product purchases will also be monitored for the same consumer—e.g. consumer takes a razor from the POP display and then subsequently takes a related product such as razor blades or shaving foam. It may be important to monitor related product purchases where subsidiary systems as described in this specification are used together. As an example, a content display may be centrally configured to display “buy razors”, but it may switch to display pre-configured related product messages such as “shaving foam half price” when the first product is picked from the display. Monitoring related product purchases would be a useful tool for optimising marketing programmes and content display strategies.

(b) Intelligence—which provides processing intelligence for brand monitoring, managing data flow between local devices e.g. by a gateway over a local communication interface, memory and the monitoring interface.

Intelligence is implemented by a software or firmware program running on a microprocessor, microcontroller, embedded PC or other embedded processing device.

Intelligent communication—in this mode of operation, the brand monitoring has the intelligence to communicate, obtain, log and process data directly with central management applications, using a gateway as a routing function only for WAN connectivity.

Non-intelligent communication—in this mode, an attached gateway provides intelligent communication with a central management application, whereby the gateway subsequently delivers configuration to the brand monitoring subsidiary system within the POP display and obtains monitored brand information.

(c) Memory—which is used for storing brand monitoring information, configuration and other information. Memory may take varied forms such as RAM, Flash, EEprom, hard disk, etc.

(d) Local communication—which provides communication with a gateway and other local devices at a remote site, such as content displays, brand alarming, stock monitoring, poster compliance devices, etc. This can take the following forms:—

NONE—where the brand monitoring is integrated with another local device e.g. gateway

WIRELINE—TTL, RS232, RS485, Ethernet, USB, Firewire, etc.

WIRELESS -802.11, Bluetooth, ZigBee, low power RF, etc.

“Horizontal POP monitoring” is mentioned above. FIG. 4a shows such a method and apparatus for POP monitoring by spring-assisted means (horizontal), which is described as follows.

The POP display apparatus 40 shown in FIG. 4a is based upon a known apparatus for dispensing brands such as cigarettes, CDs, software, etc. Brands (goods) 401 are loaded into the front or top of the POP display 40, where a spring-loaded ram 402 forces the brands 401 to be pushed to the front of the POP display 40, such that the brand 401 is easily seen by consumers and the POP display 40 appears full. As brands 401 are removed from the POP display 40, the spring-loaded ram 402 pushes forward along a slider 403.

In one embodiment, stock status is detected by measuring the position of the ram 402 relative to the back or front of the POP display 40, which position is proportional to the stock in the POP display 40.

Detecting the position of the ram 402 can be achieved in a number of ways, such as creating a “resistor ladder” along the slider 403, such that the resistance changes in relation to the ram position, which can be detected using known signal processing techniques.

Alternatively, the position of the ram 402 can be detecting using micro-switches, ultrasound, light or other known methods.

“Vertical POP monitoring” is mentioned above. FIG. 4b shows such a method and apparatus for POP monitoring by spring-assisted means (vertically), which is described as follows.

The POP display apparatus 41 shown is FIG. 4b is based upon a known apparatus for dispensing brands (goods), such as newspapers, magazines and journals, etc. Brands 401 are loaded into the top of the POP display 41, where a spring-loaded ram 402 is forced down, creating resistance in the spring 404, depending on the weight of the brands 401 in the POP display 41. The POP display 41 appears full as brands 401 are pushed to the top, such that the brand 401 is easily seen and picked up by consumers. As brands 401 are removed from the POP display 41, the spring-loaded ram 402 pushes forward to keep brands 401 at the top as weight is reduced.

One embodiment detects stock status by measuring the position of the ram 402 relative to the top or bottom of the POP display 41, which is proportional to the stock in the POP display 41 (as described for horizontal POP display monitoring above), where the position of the ram 402 relative to the top or bottom of the POP display 41 indicates stock level.

Alternatively, “dump bins” are often used for holding brands, e.g. at the ends of aisles. In this case, there may be no spring-loaded ram present and the POP display is simply filled from bottom to top. An embodiment enables a load cell (or any other weight to detection means) to be used to detect the weight of the products, which provides an indication of stock level.

“Gravity POP monitoring” is mentioned above. FIG. 4c shows such a method and apparatus for POP monitoring by gravity, which is described as follows.

The POP display apparatus 42 shown in FIG. 4c is based upon a known apparatus for dispensing brands (goods) 401 such as lipstick, razor blades, cigarettes, CDs, etc. Brands 401 are loaded into the top of the POP display 42, where gravity forces the brands 401 towards the bottom. This may be a vertical stack of brands 401 in the POP display 42, or the POP display 42 may be sloped to allow products 401 to slide to the front.

An embodiment measures the position of the brands 401 relative to the back or top (or even front) of the POP display 42, to provides an indication of stock level, and this can be done in an analogous manner to that employed in horizontal POP display monitoring, as described above.

The term “stock monitoring at the payment terminal” refers to passively monitoring bar-coded stock being purchased at a payment terminal, without affecting the payment transaction.

“Stock” is a term that relates to any bar-coded product—e.g. CDs, beverages, clothes, newspapers, tobacco, clothes, DIY items, etc.

In one embodiment, stock monitoring at the payment terminal may be achieved with a dedicated apparatus and method. Alternatively, the functionality of the apparatus and the method may be integrated within the payment terminal itself.

FIG. 3d shows four key elements of stock monitoring at the payment terminal (although others may be present), namely:

(a) Monitoring—which refers to apparatus and methods for stock monitoring at the payment terminal as described above, and includes:

Input from barcode reader—in order to monitor the barcode transaction.

Passive barcode monitoring—a high impedance monitoring circuit which monitors the barcode transaction without modifying the barcode signal or transaction in any form.

Output to the Payment terminal—the input from the barcode reader is fed directly out to the payment terminal. This is provided for ease of installation, where the stock monitoring device appears to be inserted into the barcode reader/payment terminal cable path. Alternatively, a suitable external T-cable could be provided that feeds the barcode reader signal only from the barcode reader/Payment terminal connection.

(b) Intelligence—which provides processing intelligence for stock monitoring, managing data flow between local devices e.g. by a gateway over a local communication interface, memory and monitoring interface. Barcodes hold a variety of information such as manufacturer, product code, product identifiers, etc. This unit is configured to monitor, log and communicate when (e.g. time/date) transactions of specific barcodes or barcodes associated with specified manufacturers are monitored.

Intelligence is implemented by a software or firmware program running on a microprocessor, microcontroller, embedded PC or other embedded processing device.

Intelligent communication—in this mode of operation, the stock monitoring subsidiary system has the intelligence to communicate, obtain, log and process data directly with central management applications, using a gateway as a routing function only for WAN connectivity.

Non-intelligent communication—in this mode, an attached gateway provides intelligent communication with a central management application, whereby the gateway subsequently delivers configuration to the stock monitoring device at the payment terminal and obtains the monitored stock information.

(c) Memory—which is used for storing stock monitoring information, configuration and other information. Memory may take varied forms such as RAM, Flash, EEprom, hard disk, etc.

(d) Local communication—which provides communication with a gateway and other local devices at the remote site, such as content displays, brand alarming, brand monitoring, poster compliance devices, etc. This can take the following forms: —

NONE—where the stock monitoring is integrated with another local device e.g. gateway.

WIRELINE—TTL, RS232, RS485, Ethernet, USB, Firewire, etc.

WIRELESS—802.11, Bluetooth, ZigBee, low power RF, etc.

The term “brand alarming at the content display” or “brand alarming” is used to describe alarm information about specific brands or products, where brand alarming information is likely to be warning or instructions that a person or operator needs to read, check, carry out or verify—such as product recall information and instructions, for example.

FIG. 3e shows five key elements of brand alarming at the content display, namely:

(a), (b), (c) and (d)—These four elements can be grouped together and may be as described under “content display” above, with reference to FIG. 3b. For example, product recall information is displayed on the content display.

(e) Acknowledgement (ACK)—In this embodiment, the Content Display additionally integrates an acknowledgement element, whereby an authorised user or contact acknowledges that the displayed content—e.g. product recall information—has been received and understood. Furthermore, it provides a means to notify current status to any instructional content. E.g. a product recall message will firstly need acknowledgement that the message has been received, but also that the stock has been successfully removed from possible purchase. Acknowledgements could be provided by any input device such as a button, keypad, RF key fob, switch, mobile phone text message, etc., whether it includes a coded sequence, unique or multiple events.

The term “brand alarming at the payment terminal” will now be explained. “Brand alarming” has previous been described. In this embodiment, it is integrated within a device at a payment terminal or within the payment terminal directly.

“Brand alarming at the content display” has previously been described, where information is sent to content displays. In this embodiment, product recall information and associated “potential” barcodes are sent to a brand alarming device at a payment terminal.

“Brand monitoring at the payment terminal” has previously been described, where specific stock barcode transactions are monitored at the payment terminal. In this embodiment, potential product recall barcode transactions are detected.

FIG. 3f details five key elements of brand alarming at a payment terminal, namely:

(a), (b), (c) and (d)—These four elements can be grouped and as described earlier with reference to FIG. 3d “stock monitoring at the payment terminal”. In this case, potential product recall barcodes are specifically being monitored for. The intelligence within this unit will determine potential product recall barcodes, which need to be communicated to a local operator.

(e) Operator Interface—an operator interface is used to communicate with the operator. The local operator needs to verify full product recall information.

An audible or visual warning may be given to draw the operator's attention to a potential product recall alarm. A local display such as an LCD display, content display or other output device may be used to communicate full instructions for verification.

An input device such as a keypad, switch or button, etc. will enable an operator to acknowledge whether a barcode transaction is for a recalled product or otherwise. If it is, the product can be recalled from sale and the sales transaction cancelled.

Acknowledgements or otherwise may monitored as part of stock transaction monitoring.

The term “poster compliance” will now be explained.

“Poster” is a term used to describe any documentation intended for display at a remote site, such as Point of Purchase (POP) material for advertising, marketing and promotions, etc. Furthermore, it includes billboards, posters, leaflets, brochures, labels, collateral or regulatory conformance such as certificates for health and safety, fire, environmental compliance, etc.

“Posters” are issued to remote sites for display, where the remote site is responsible for displaying the posters in a suitable holder, frame, display stand, billboard, etc. This is often as part of an agreement between parties, e.g. franchiser and franchisee, head office and retail store, etc. As such, the remote site is expected to comply with the agreement.

This subsidiary system provides a method and apparatus for monitoring and identifying posters at a remote site.

FIG. 3g shows two distinct elements of a poster compliance unit, as follows.

(a) Poster—a poster dispatched to the remote site which is placed within a poster holder for display at the remote site. The poster contains an integrated barcode which provides identification information about the poster.

The barcode may be a standard barcode detected by known optical means or a “simple barcode” which is detected by Infrared (iR) means.

A “simple barcode” is described as a series of bars which either reflect or do not reflect an iR signal. As an example, a black bar will not reflect an iR signal, whereas a white bar will reflect an iR signal.

A combination of reflecting/non-reflecting (white/black) bars provides identification information—e.g. 5 bars provides 32 combinations to identify up to 32 types of individual posters. For each additional bar, the number of combinations is doubled.

(b), (c), (d), (e) and (f) Poster Holder—The poster holder displays the poster and contains a number of units (described below) which detect bar-coded information on the poster and communicate it to a local device or directly to a remote device.

The six key elements shown in FIG. 3g will now be described in further detail.

(a) Poster—this is as described above.

(b) Detector—A detector built into the poster holder which identifies a barcode on the poster.

The detector may be a standard optical barcode reader where a standard barcode has been used on the poster, or it may be a “simple barcode reader” where a simple barcode has been used on the poster.

A “simple barcode reader” may comprise an iR transmitter and receiver pair for each “bar” of the series of bars on the poster. An iR signal is transmitted for each potential bar, where a reflected signal is monitored for at the iR receiver.

If no signal is received, this indicates no poster in the poster holder. Reflecting bars of the poster will enable an iR signal to be received and detected.

(c) Intelligence—provides processing intelligence for poster compliance, managing data flow between local devices e.g. by a gateway over a local communication interface, memory and detector interface.

Intelligence is implemented by a software or firmware program running on a microprocessor, microcontroller, embedded PC or other embedded processing device.

Intelligent communication—in this mode of operation, the poster compliance unit has intelligence to communicate, obtain, log and process data directly with central management applications, using a gateway as a routing function only for WAN connectivity.

Non-intelligent communication—in this mode, an attached gateway provides intelligent communication with a central management application, whereby the gateway subsequently delivers configuration to the poster compliance unit and obtains poster compliance information.

(d) Memory—which is used for storing poster compliance information, configuration and other information. Memory may take varied forms such as RAM, Flash, EEprom, hard disk, etc.

(e) Local communication—which provides communication with the gateway and other local devices at the remote site, such as content displays, brand alarming, stock monitoring, etc. This can take the following forms:—

NONE—where the poster compliance is integrated another local device e.g. gateway.

WIRELINE—TTL, RS232, RS485, Ethernet, USB, Firewire, etc.

WIRELESS—802.11, Bluetooth, ZigBee, low power RF, etc.

(f) Power—which provides a power source for all elements within the poster compliance unit. This may take power from an external source. However, in many cases an integrated battery may be used to supply power to the poster compliance unit elements where external powering is not possible or where installation is difficult—e.g. window display.

FIG. 5a shows one method for mounting a poster 511 in a poster frame or holder and illustrates methods for identifying posters 511 as described above. It shows the poster 511 mounted in the poster frame, with a barcode 515 at the rear. The front 512 of the poster holder keeps the poster 511 against the back 513 of the poster frame. A barcode reader or simple barcode reader 514 on the rear of the poster holder is aligned with the poster code 515, such that the code 515 can be detected as described.

FIG. 5b shows an alternate method for mounting posters in the form of leaflets 511 in a leaflet holder or dispenser 516. In this case, gravity is used to keep the leaflets 511 against the rear of the leaflet holder 516. This is important where the leaflets 511 can be dispensed from the leaflet holder 516. This method detects when the leaflet dispenser 516 is empty and the type of leaflet 511 in the dispenser 516.

Barcodes 515 may be detected in a similar way to that described with reference to FIG. 5a.

FIG. 5c shows an alternate method for mounting leaflets 511 in a leaflet holder 516. In this case, a spring 517 is used to keep the leaflets 511 against the rear of the leaflet holder 516.

This is important where leaflets 511 can be dispensed from the leaflet holder 516. This method detects when the leaflet dispenser 516 is empty and the type of leaflet 511 in the dispenser 516. Barcodes 515 may be detected in a similar way to that described with reference to FIG. 5a.

“Other device monitoring” is a term that describes the monitoring of devices at a remote site, other than as otherwise described within this document.

In this case a “device” may be a physical device such as a utility meter (electricity, gas, water, etc.), heating, ventilation, air conditioning, refrigeration device, etc.

However, this term also refers to monitoring parameters and conditions that are externally sensed from a specific device or location, such as ambient temperature and temperatures at specific locations.

The subsidiary systems described herein disclose infrastructures that can be used for other device monitoring. With an infrastructure justified for the subsidiary systems described, this simplifies additional circuitry and therefore lowers the cost and justification for other device monitoring.

FIG. 3h shows four key elements of other device monitoring, namely:

(a) Monitoring—which is the sensing element for monitoring any external device or condition, such as:

device—e.g. utility meter, HVAC, refrigeration, security system, access control, lighting system, gaming machine, vending machine, beverage dispenser, EPOS system, etc.;

condition—temperature, light level, humidity, pressure, weight, etc.;

sensing means—thermal, voltage, current, keypad, optical, ultrasonic, weight, position, etc.

(b) Intelligence—which provides processing intelligence for other device monitoring, managing data flow between local devices e.g. by a gateway over a local communication interface, memory and monitoring interface.

Intelligence is implemented by a software or firmware program running on a microprocessor, microcontroller, embedded PC or other embedded processing device.

Intelligent communication—in this mode of operation, the unit has intelligence to communicate, obtain, log and process data directly with central management applications, using a gateway as a routing function only for WAN connectivity.

Non-intelligent communication—in this mode, an attached gateway provides intelligent communication with a central management application, where the gateway subsequently delivers configuration to the “other device monitoring” and obtains the monitored information.

(c) Memory—which is used for storing “other device monitoring” information, configuration and other information. Memory may take varied forms such as RAM, Flash, EEprom, hard disk, etc.

(d) Local communication—which provides communication with a gateway and other local devices at the remote site, such as content displays, brand alarming, stock monitoring, poster compliance devices, etc. This can take the following forms:—

NONE—where the brand monitoring is integrated another local device e.g. gateway.

WIRELINE—TTL, RS232, RS485, Ethernet, USB, Firewire, etc.

WIRELESS -802.11, Bluetooth, ZigBee, low power RF, etc.

Remote site distributed and/or integrated architecture will now be explained.

The remote site elements, as described above, are connected together in either a “distributed” or “integrated” architecture, which then connects to the WAN and central management system(s) to create the various subsidiary systems.

The term “distributed” refers to discrete remote site elements as described, which have been locally networked together. This includes any combination of remote site elements in any quantity e.g. one gateway element networked with two content displays.

FIG. 3i shows an example of a distributed solution, where local network elements provide connectivity between dedicated remote site elements. These elements may be physically distributed around the remote site, or they may be distributed within a specific area or asset such as within a POP display.

The term “integrated” refers to the integration of a plurality of remote site elements into a single discrete element. This includes any combination of remote site elements in any quantity, e.g. one gateway, two content displays and a brand monitoring device into one integrated solution. As an example, this may be well suited to installation into a standalone POP display.

As part of the integration, any common resources such as memory, intelligence and local communication may be rationalised into one resource rather than having duplications of the same resource.

FIG. 3j shows an example of an integrated solution, where common local communication (e.g. TTL), memory (e.g. flash) and intelligence (e.g. microcontroller) are integrated with display (content display), monitoring (brand monitoring) and remote communication (Gateway) elements, thereby to minimise or avoid duplication of common functions.

In this case, the shared resources (microcontroller and memory) will be integrated with the appropriate controlling intelligence from each remote site element, e.g. gateway functionality firmware, content display functionality firmware and brand monitoring functionality firmware on a common platform.

For clarity, architecture includes distributed, integrated or a combination of distributed AND integrated.

An example of the above-mentioned subsidiary system (1) will now be described with reference to FIGS. 6a to 6c, which show a centrally managed system for delivering content and monitoring the response at remote sites.

It is known that delivering “content” to displays such as LED, Plasma and video displays located in-store at a retailer can influence the purchase of goods by consumers; e.g. “content” such as advertising. The method of system (1) is used to help increase the sales of goods where associated “content” is displayed.

The problem lies with understanding the effectiveness of the delivered “content” in influencing purchasing decisions made by the consumer. Goods purchased in-store are taken from the shelf or POP display and paid for at a payment terminal at another location in-store. This goods sales transaction is processed by the retailer's business systems, which are often separate from the business systems of the brand owners of the purchased goods. This often results in a slow response to monitoring the effectiveness of promotions.

This system (1) provides a means of delivering “content” from a central location to displays at remote retail sites together with a means of monitoring the response (or customer behaviour) without reliance on the retailers business systems or IT infrastructure. This enables brand owners or other stake holders to monitor the effectiveness of promotions or campaigns. As a result, campaigns can be changed rapidly in response to consumer demographic purchase decisions as a means to maximise brand sales and minimise the use of expensive and slower paper based POP material.

It is envisaged that, typically, there will be human user intervention to respond to monitored response. However, it is possible that intelligent electronic devices (e.g. computers) could receive and interpret monitored response and modify displayed content accordingly. For example, a computer could try different content scenarios at different times and respond automatically to the monitored response.

Responses to the displayed “content” at the remote site include the purchase of goods for advertising or promotional “content” or the acknowledgement or fulfillment of displayed instructional “content”. This aids marketing and monitoring of brand purchases within retail stores such as supermarkets, grocery stores, convenience stores, mass merchandising outlets, drug stores, specialty retail outlets (e.g., pet stores, record stores, book stores), consumer electronics stores, etc.

“Displays” is a broad term including not only traditional displays such as LCD, LED, Plasma, Video, TFT, etc. but also lighting sources such as LED, fluorescent, incandescent, sodium, halogen, etc. which are used for accent lighting of individual or groups of products or locations. Displays may be stand alone displays located at in-store locations near the associated brand, in the window to attract passer-bys, outside the shop or integrated within brand specific POP displays.

Monitoring of consumer response may be achieved by passively monitoring barcode transactions of goods being purchased at the payment terminal, movement of stock position within the shelf, RFID, weight, etc. Passive monitoring of barcodes may be achieved in a novel manner by feeding scanned barcode information in parallel to both the retailer's regular IT system and to a monitoring unit of the system (1). The latter unit may be restricted to detecting only pre-determined goods, so that information relating to all goods is not passed back to the central management application of the system (1), and therefore the retailer's information as to overall customer transactions can remain confidential to the retailer.

Communication between display/monitoring and the central site may be achieved via wireless (GSM, GPRS, CDMA, 3G, etc.) or Wireline (ADSL, Ethernet, PSTN, etc.) technologies.

Central site management applications may be an integrated content delivery and monitoring application, separate systems, or existing management systems owned by merchants where a broker management system provides integration between a plurality of retail site systems and a plurality of third party management systems.

This system reduces the reliance on the retailer to provide sales data to brand owners and merchants and eliminates the need to utilise the retailer IT infrastructure and business systems. It may provide rapid feedback on the effectiveness of display marketing campaigns and enable campaigns to be optimised for customer demographics. It may be utilised, for example, at any retail store for consumer goods, food and drink, pharmaceuticals, newspapers, groceries, white goods, brown goods, music, computers, etc.

FIG. 6a shows a high level view of the system (1), where content configured by users 21 at a central management system 2 is delivered to a content display 32 at a remote site 3 via a gateway 31 located at a remote site 3 and WAN 4. The response to the content 33 is automatically monitored 34 at the remote site 3 by brand monitoring within a POP display and/or stock monitoring at a payment terminal; and monitored information is delivered back to the central management system 2 via the gateway 31 and the WAN 4.

Typically, the displayed content will relate to brands monitored, in order to determine the effectiveness of promotions, etc.

The consumer may take products from a shelf where a purchasing decision has been influenced by the content display 32 and pay for them at a payment terminal, which is typically at another location in-store.

Remote site 3 elements gateway 31, content display 32, brand monitoring and/or stock monitoring 34 may have a distributed and/or integrated architecture.

Preferably, the status of the content display 32 is monitored and reported back to the central management system 2, so that a user 21 may know the status of the content display 32—e.g. is it switched on, has it acknowledged receipt of content, etc. Such status reporting may be utilised in any relevant parts of other systems described herein.

FIG. 6b shows one embodiment where the content display 32 is located near a retailer's products 321, where any stock taken from the shelf is monitored at the payment terminal 35.

FIG. 6c shows another embodiment where the content display 32 and brand monitoring 341 are integrated within a POP display 322, together with the gateway. In this case, monitoring is not reliant upon stock being monitored at the payment terminal 35, either through the retailer's IT system or at stock monitoring devices. Further content display 32 may be provided at other locations.

Central users 21 are able to see the impact of specific content displayed at remote sites in the form of stock sales or brands taken from the POP display 322. This enables central users 21 to analyse purchase and create strategies for displaying appropriate content that maximises stock and brand transactions, i.e. content can be changed through monitored feedback from the remote site 3. This includes strategies and centrally configured instructions for related product purchases as described above in “brand monitoring”.

In addition to content, the central management system 2 may also download any configuration parameters associated with each remote site 3 element, such as gateway 31 configuration (e.g. communication settings), content display 32 configuration (e.g. display strategies) and brand monitoring 34 configuration (e.g. alarm thresholds).

Communication of stock and brand information may be initiated on a scheduled time basis, upon detecting/clearing an alarm condition (e.g. stock low), when requested by the central management system, or immediately when there is a change in status.

Brand monitoring within a POP display is described subsequently as a separate system (2) in its own right, but in this case combines with content displays.

Stock monitoring at a payment terminal is described as a separate system (3) in its own right, but in this case combines with content displays.

As shown in FIG. 1, the systems of FIGS. 6a, 6b and 6c can share infrastructure with other systems, namely subsidiary systems (2) to (5) as mentioned above, and also “other device monitoring”.

An example of the above-mentioned subsidiary system (2) will now be described with reference to FIGS. 7a and 7b, which show a centrally managed system for remote site Point of Purchase (POP) display monitoring.

POP displays are sometimes managed and re-stocked by parties in-store other than the retailer, such as the brand owner or other merchants. Goods sales transaction are processed by the retailer's business systems, which are often separate from the business systems of the brand owners or merchants of the purchased goods. This often results in a slow response to monitoring the stock levels and can result in under stock causing lost sales, over-stock or in-efficient supply chain operations

The system (2) provides a means of monitoring stock levels without reliance on the retailer's business systems or IT infrastructure. This enables brand owners or other stake holders to monitor stock levels in real-time and monitor the effectiveness of promotions or campaigns. This improves inventory management, supply chain logistics and maximises sales revenues. Furthermore, it provides trend information that enables brand owners and merchants to understand consumer buying patterns, which is an invaluable tool when combined with promotional campaigns.

The system (2) and its method of operation provide for monitoring a plurality of remote POP displays from a central site. This includes monitoring stock taken and replenished on the display, the presence of consumers, ambient conditions such as temperature, lighting and local promotion information through electronic displays or posters, etc. This aids marketing and monitoring of brand purchases within retail stores such as supermarkets, grocery stores, convenience stores, mass merchandising outlets, drug stores, specialty retail outlets (e.g., pet stores, music stores, book stores), consumer electronics stores, etc. The system (2) automatically provides information to a central site from remote in-store retail POP displays.

POP displays are display structures made from cardboard, plastics, metal or other materials that store and present brands of products for sale to consumers. Various methods are provided for detecting the presence of products on the POP display, stock movement on/off the display, together with potentially detecting the status of external conditions such as temperature, lighting, footfall and the presence of promotional material, etc.

Products within POP displays are normally presented to the front of the shelf; the system (2) may primarily detect the position of stock in the display to determine stock levels and transactions. POP displays may be stand alone displays located at in-store locations, outside the store or located in public areas such as railway platforms. Furthermore, there may be more than one POP display at a remote site. Any information monitored is temporarily stored within the POP display and/or immediately communicated back to a central management application. For a standalone POP display, wide area communication is integrated directly into the POP display eg utilising GSM, GPRS, etc.

Where there is more than one POP display at the remote site, these are locally networked using technologies such as local wireless (ZigBee, low power radio, etc.). In this case, wide area communication with the central management application is achieved with GPRS type technologies built into one of the POP displays, an external gateway unit or perhaps using the retailer's own network.

Communication between remote site (one or more POP displays) and the central site is therefore achieved via wireless (GSM, GPRS, CDMA, 3G, etc.) or Wireline (ADSL, Ethernet, PSTN, etc.) technologies.

Central site management applications may be a dedicated monitoring application or existing management systems owned by merchants where a broker management system provides integration between a plurality of retail site systems and a plurality of third party management systems.

This system reduces the reliance on the retailer to provide sales data to brand owners and merchants and eliminates the need to utilise the retailer's IT infrastructure and business systems. It may provide rapid feedback on stock status, which is particularly powerful when combined with marketing campaigns such as advertising through electronics displays, leaflets or posters, etc.

It can be utilised at any retail store for consumer goods, food and drink, pharmaceuticals, newspapers, groceries, white goods, brown goods, music, computers, etc.

FIGS. 7a and 7b shows a high level view of the system, where brand monitoring 341 within a POP display 322 is effected and monitored information is delivered back to a central management system 2 via an integrated gateway 341 and WAN 4. Various ways of brand monitoring within a POP display 322 are described in the foregoing description.

There may be one or more POP displays 322 with integrated monitoring 341 at the remote site 3. Remote site elements gateway and/or brand monitoring 341 may have a distributed and/or integrated architecture.

The central management system 2 will also download any configuration parameters associated with each remote site 3 element, such as gateway 31 configuration (e.g. communication settings) and brand monitoring configuration (e.g. alarm thresholds).

Communication of brand monitoring information is initiated on a scheduled time basis, upon detecting/clearing an alarm condition (e.g. brand level low), when requested by the central management system 2, or immediately when there is a change in status.

This system enables stock on POP displays 322 to be remotely monitored to aid replenishment by third parties and enables brand owners to monitor response to promotions, etc.

As shown in FIG. 1, the systems of FIGS. 7a and 7b can share infrastructure with other systems, namely subsidiary systems (1) and (3) to (5) as mentioned above, and also “other device monitoring”.

An example of the above-mentioned subsidiary system (3) will now be described with reference to FIG. 8, which shows a centrally managed system for stock monitoring at remote sites.

There is a growth trend in selling a brand or brands of products operating as a concession within a retail store; this could be considered as a “store within a store” which utilises the retailer's payment systems and IT infrastructure. In this case, the brand owners are responsible for stock replenishment rather than the retailer.

Due to the slow nature of obtaining sales information from the retailers' systems, the brand owners have problems with over and under stock situations, which impact sales revenues and create inefficiencies in the supply chain logistics. Similar problems exist for magazines, newspapers and other short shelf-life or perishable products, where the responsibility for crediting or disposing of unsold products lies with the supplier. As an example, publishers will ship magazines based on a retailer's forecast. However the publisher will credit the retailer for any unsold products. In this case, the publisher is dependant on the retailers forecast, which often result in over-stock, high levels of waste and associated disposal charges.

The system (3) provides a means of monitoring stock at remote sites in real-time and reporting status to the brand owner or supplier without reliance on the retailer. This enables greater control and management of stock shipped to a retailer concession or retail store, thereby to prevent over and under stock conditions to maximise sales, improve supply chain logistics, reduce waste and associated disposal costs.

The system (3) may provide a method for centrally monitoring stock at a plurality of remote sites. This includes stock purchased at payment terminals by passively monitoring barcodes and as a separate embodiment, monitoring any stock that has been counted in a backroom store or on display by a person using a hand-held device such as a PDA. This aids supply chain logistics by monitoring brand purchases within retail stores such as supermarkets, grocery stores, convenience stores, mass merchandising outlets, drug stores, specialty retail outlets (e.g., pet stores, music stores, book stores), consumer electronics stores, etc.

Monitoring stock purchased at a retail store by passively monitoring the barcode between the barcode reader and the payment terminal does not interfere, alter or modify the barcode transactional data.

A passive barcode detector could be a dedicated box which is connected between an existing retailer's barcode scanner and reader, or it could be built into a barcode reader or built into a payment terminal.

A monitoring device may communicate with a central management system either directly, via a network which is independent of the retailers IT systems, or potentially by the retailer's own network. The monitoring device may be centrally configured to monitor specific brands of products. As an example, a publisher may monitor a selection of magazine sales, or a concession brand owner may monitor its brands through the retail concessionaire's payment terminals.

The monitoring device may temporarily store sales transactions (barcodes, time, date, etc.) for specific brand sales transactions or it may pass on the data for immediate communication. There may be more than one barcode monitoring device in a retail store

Barcode monitoring devices may communicate gathered information to an onsite gateway device, which may in turn provide logging and filtering capabilities. The gateway may be standalone, integrated with the barcode monitoring device or integrated within other equipment such as a POP display or electronic sign as part of a third party network.

Communication between remote and the central site may be achieved via wireless (GSM, GPRS, CDMA, 3G, etc.) or Wireline (ADSL, Ethernet, PSTN, etc.) technologies.

The gateway device may deliver all the gathered data to one central site or it may enable the data to be routed to different central systems—e.g. monitoring multiple brands and routing to individual brand owners.

Central site management applications may comprise a dedicated monitoring application or existing management systems owned by merchants, where a broker management system provides integration between a plurality of retail site systems and a plurality of third party management systems. In the latter case, the remote gateway sends all its data to the broker and the broker routes and buffers the data to individual brand owners.

As a further embodiment, a handheld unit such as a PDA with integrated barcode reader can be used to count stock in a backroom store and on display, which can be transferred through the gateway to report non-transactional stock status. This may be done by, for example, an operator of an in-store franchise. This enables brand owners to understand stock status for accurately forecasting replenishment to improve supply logistics, ensure stock does not run out, minimise disposal and losses and increase revenues.

The system (3) may reduce reliance on a retailer to provide sales data to brand owners and merchants and eliminate the need to utilise the retailer's IT infrastructure and business systems. It may provide rapid feedback on stock status, which can be particularly powerful when combined with marketing campaigns such as advertising through electronics displays, leaflets or posters, etc. It may be utilised at any retail store for consumer goods, food and drink, pharmaceuticals, newspapers, groceries, white goods, brown goods, music, computers, etc.

FIG. 8 shows a high level view of the system, where stock monitoring is effect at a payment terminal 35; and monitored information is delivered back to a central management system 2 via a gateway 31 and WAN 4. Various methods/types of apparatus for stock monitoring are described above with reference to stock monitoring at the payment terminal. There is also an option for a hand held unit such as a PDA with an integrated barcode reader to count stock in a backroom store or on display, which unit transfers the monitored information to the central management system 2 via the gateway 31 and the WAN 4.

There may be one or more payment terminals with associated stock monitoring at the remote site.

Remote site elements gateway 31 and stock monitoring may have a distributed and/or integrated architecture.

The central management system 2 may also download any configuration parameters associated with each remote site element, such as gateway 31 configuration (e.g. communication settings) and stock monitoring configuration (e.g. stock ID to be monitored).

Communication of stock monitoring information is initiated on a scheduled time basis, upon detecting/clearing an alarm condition (e.g. stock low), when requested by the central management system, or immediately when there is a transaction.

This system enables brand owners, concessionaires, etc. to understand stock sales to aid replenishment and minimise waste of short shelf-life products such as newspapers, for example.

As shown in FIG. 1, the system of FIG. 8 can share infrastructure with other systems, namely subsidiary systems (1), (2), (4) and (5) as mentioned above, and also “other device monitoring”.

An example of the above-mentioned subsidiary system (4) will now be described with reference to FIG. 9, which shows a centrally managed system for brand alarming at remote sites.

“Product recalls”, as a result of manufacturing problems, contamination or food terrorism, etc. are currently a manual process, whereby notices are sent to retailers and published in magazines to advise removal of specific products and/or product batches from the shelf and from sale. Furthermore, there is a slow or non-existent process of compliance to determine whether retailers have complied. Non-compliance, due to delays, may threaten the health and safety of a retailer's customers.

The time between first notification and known compliance is critical, as is the time between retailers receiving a product recall and removing products from the shelf, during which time it is likely that customers may have already picked a recalled product from the shelf.

The system (4) provides a means of delivering product recall information directly to a retail store for rapid distribution of information, which requires an acknowledgement to report compliance that the message has firstly been received, and also that the stock has been removed from the shelf. In a further embodiment, purchases are monitored at the payment terminal and checked against a potential black list of recalled products. Upon detecting the barcode of a potential black listed recalled product, an alarm is generated, which prompts the terminal operator to check for further product recall information, such as batch codes, etc.

This enables manufacturers, suppliers, retailers, merchants and governing bodies to rapidly distribute product recall information and gain rapid acknowledgement of compliance, such that escalation procedures can be invoked with non-compliant retailers. By minimising time between notification and full compliance, this will potentially save lives and reduce health & safety hazards.

The system (4) may provide a method for centrally delivering brand information and instructions to a plurality of remote sites, such as product recall information, whereby an acknowledgement is monitored for compliance purposes. As a further embodiment, such information may be used to automatically alarm on any sales transactions that include the product recall information, by passively monitoring barcodes at the payment terminal. This aids product recall within retail stores such as supermarkets, grocery stores, convenience stores, mass merchandising outlets, drug stores, specialty retail outlets (e.g., pet stores, music stores, book stores), consumer electronics stores, etc.

The system (4) enables “product recall” information to be configured at a central management system—such as product description, barcode information, batch codes, dates, etc. This information can be input by government agencies, manufacturers, third parties, etc. The product recall information may be automatically distributed over a wide area network such as GSM, GPRS, the Internet, etc. to electronic displays located within retail stores

An electronic display within a retail store may display the product recall information and provide a sounder or buzzer to alert staff of the product recall notice. An acknowledgement is required that the displayed product recall information has be received, read and understood—e.g. a designated store contact such as a manager inputs a PIN code via a keypad on the display, similar to deactivating an security panel alarm. This acknowledgement is logged within the electronic display and automatically communicated to the central management application via the wide area network. The display may prompt the store contact to get further “product recall” information from a website.

The system (4) may require the store contact to input a separate acknowledgement that the store has fully complied with the product recall notice—i.e. that the entire recalled product has been removed from sale.

Where products purchased at a payment terminal are monitored by passively monitoring a barcode between a barcode reader and the payment terminal, this may not interfere, alter or modify the barcode transactional data.

Barcode monitoring devices may be locally networked with each other (where there is more than one payment terminal) and networked with the product recall electronic display. This network will onward communicate with a central management system, where the wide area communication may be a dedicated product or integrated within either the electronic displays or one of the barcode monitoring devices.

When a product recall message is received at the retail store, the barcode monitoring device is configured with and maintains a blacklist of potential product recall information. Should a barcode be detected that resides on the blacklist, then an alert is generated such as a sounder, where the operator is prompted to check additional information such as batch codes, sell by dates, etc., which verify if the detected product has been notified for recall.

The system (4) may enable rapid delivery of product recall information and provide compliance information back to the central site in order to invoke escalation procedures for non-compliance. It can be utilised at any retail store for consumer goods, food and drink, pharmaceuticals, newspapers, groceries, white goods, brown goods, music, computers, etc.

Since the primary function of system (4) operates in the background, the display, barcode monitoring and communication infrastructure can be used for other related systems, such as stock monitoring, content display and monitoring for advertising, where the combined functionality enables a business case to be justified for the present system where revenues can be generated by offering services to brand owners, concessionaires, etc.

FIG. 9 shows a high level view of the system, in which content configured by users 21 at one or more central management system 2 is delivered to a brand alarming content display 323 at a remote site 3 via a gateway 31 located at the remote site 3 and WAN 4; and the response to the content at the remote site 3 in the form of acknowledgements monitored at the brand alarming content display 323 is delivered back to a central management system 2 via the gateway 31 and the WAN 4.

Content or product recall information (barcodes, etc.) configured by users 21 at the central management system(s) 2 may also or alternatively be delivered to a brand alarming point at a payment terminal 35 at a remote site 3 via the gateway 31 and the WAN 4; and the response to the content at the remote site 3 in the form of acknowledgements monitored at the brand alarming point at the payment terminal 35 delivered back to the central management system 2 via the gateway 31 and the WAN 4.

There may be one or more payment terminals 35 with associated brand alarming at the remote site 3. There may be one or more brand alarming content displays 323 at the remote site 3.

Remote site 3 elements gateway 31, brand alarming at content displays 323 or brand alarming at payment terminals 35 may have a distributed and/or integrated architecture.

The central management system 2 may also download any configuration parameters associated with each remote site 3 element, such as gateway 31 configuration (e.g. communication settings), brand alarming at the payment terminal configuration (e.g. stock ID to be monitored, blacklists, etc.), and brand alarming at the content display (e.g. audible alarm control, etc.).

Communication of brand alarm status information (acknowledgements, transactions, etc.) is initiated on a scheduled time basis, upon detecting/clearing an alarm condition (e.g. acknowledgement), when requested by the central management system 2 or immediately when there is a change in status.

This system enables rapid distribution of product recall information and monitoring of the response to aid escalation procedures for compliance. In turn, this may minimise harm to the public.

As shown in FIG. 1, the system of FIG. 9 can share infrastructure with other systems, namely subsidiary systems (1) to (3) and (5) as mentioned above, and also “other device monitoring”.

An example of the above-mentioned subsidiary system (5) will now be described with reference to FIG. 10, which shows a centrally managed system for Point of Purchase (POP) poster compliance at remote sites.

In a retail store, timely and effective communication of goods information is essential for retailers, brand owners and consumers. This is achieved by Point of Purchase (POP) material being dispatched from central locations to retail stores for display, which conveys information such as advertising, promotions and marketing information. This is also applicable to advertising of goods or services through posters, billboards and leaflets located where there are passing consumers or a captive audience such as at bus-stops, banks, post-offices and payment terminals, etc.

This is often tied in with promotional events where the effectiveness of the campaign is measured over a period of time, during which there is a reliance upon the retailer or a third party to display the POP material. The problem lies with compliance, such that the originator (head office, franchiser, brand owner, etc.) often does not know whether the retailer has presented the POP material correctly—e.g. it may reside with backroom stock. As a result, marketing results are often skewed, leading to non-take-up of effective campaigns, resulting in lost revenue.

The system (5) provides a means of centrally monitoring whether retailers have complied with presenting specific POP material, without reliance upon the retailers' business or IT systems. This enables originators to monitor the effectiveness of promotions or campaigns by ensuring posters and leaflets are presenting the right POP material throughout the campaign, and escalate any procedures where retailers do not comply.

The system (5) provides a method for monitoring a plurality of remote POP material displayed within a dispenser from a central site. This includes monitoring posters within a poster frame and also leaflets within a leaflet holder, to aid marketing campaigns and compliance with agreed instructions. This aids marketing and monitoring of POP material within retail stores, such as supermarkets, grocery stores, convenience stores, mass merchandising outlets, drug stores, specialty retail outlets (e.g. pet stores, music stores, book stores), consumer electronics stores, etc. However this is also applicable for advertising at bus-stops, areas where there is a captive audience such a banks, post-offices, urinals, etc. Furthermore, this is applicable for regulatory conformance notices such as health and safety, insurance declarations, liability declarations or other workplace or public notice legislative requirements.

The system (5) provides a holder such as a poster frame or leaflet dispenser, as a receptacle for displaying POP material—e.g. a poster or leaflets. It further provides a method for detecting and identifying the POP material that has been placed in the holder, such that a central user can monitor the compliance of the retailer in displaying the correct POP material in-store or at locations such as billboards and advertising panels at locations such as bus-stops, urinals, etc. where there is a captive audience.

Various methods are possible for detecting the presence and identification of POP material in the holder, such as barcodes. In one embodiment, the holder emits a non-visible light source such as Infrared (iR) which is either reflected from a white surface or not reflected from a black surface on the POP material that is placed in the holder. The holder detects the reflection (or non-reflection) of the light to identify if POP material is located within the holder. Furthermore, it is possible to identify the POP material by having multiple pairs of light source and detectors, whereby the POP material has a sequence of white and black areas as a code for identification. As an example, 5 pairs of emitters and detectors would enable 32 unique types of POP material to be identified.

This is a crude form of barcode labelling that offers lower cost than a traditional barcode solution. However, the system also caters for detection using traditional barcode methods. Traditional barcodes have the advantage that a greater amount of information could be encoded and identified—e.g. campaign, dates, etc.

The detecting device within the holder would typically be battery powered and wake up at defined intervals to detect the status of the POP material within the holder. In some cases, power is present within the holder—e.g. for back lighting the POP material, in which case the device can be powered externally.

The POP material status is communicated to a gateway device in-store, which is then communicated to a central management application over a Wide Area Network (WAN) such as GPRS, GSM, the Internet, etc. The central management application gathers and manages information from all remote sites and holders and presents information to users to aid compliance and escalation of non-compliance.

For isolated or single holders, gateway functionality may be built directly into the holder. Alternatively, an external gateway may offer WAN capabilities for more than one on-site holder, where communication between the gateway and the on-site holders may be via local RF or wired means. Communication between gateways and the central site may be achieved via wireless (GSM, GPRS, CDMA, 3G, etc.) or Wireline (ADSL, Ethernet, PSTN, etc.) technologies.

The system (5) may provide rapid feedback on a retailer's compliance with marketing campaigns. It can be utilised at any retail store for consumer goods, food and drink, pharmaceuticals, newspapers, groceries, white goods, brown goods, music, computers, etc.

FIG. 10 shows a high level view of the system for poster compliance, where monitored information on the status of posters 511 in a poster holder 516 is delivered back to a central management system 2 via a gateway 31 and WAN 4. Methods and types of apparatus for poster compliance are described above with reference to poster compliance.

There may be one or more poster compliance unit at the remote site 3.

Remote site elements gateway 31 or poster compliance unit may have a distributed and/or integrated architecture.

The central management system 2 may also download any configuration parameters associated with each remote site 3 element, such as gateway 31 configuration (e.g. communication settings) and poster compliance configuration (e.g. expected poster ID).

Communication of poster status information is initiated on a scheduled time basis, upon detecting/clearing an alarm condition (e.g. no or incorrect poster), when requested by the central management system, or immediately when there is a change in status.

This system enables head offices, franchisers and regulatory bodies, etc. to monitor that remote sites comply with agreed display of documentation to improve marketing promotions and legislation compliance.

As shown in FIG. 1, the system of FIG. 10 can share infrastructure with other systems, namely subsidiary systems (1) to (4) as mentioned above, and also “other device monitoring”.

FIG. 11 shows how the above-described system (5) for POP poster compliance may be adapted for further purposes.

Machines that dispense stock, e.g. vending machines, often dispense multiple stock items from hoppers or stock dispensers within the machine. When these stock dispensers are manually refilled, the person re-stocking may choose to re-organise the stock to be dispensed—e.g. more than one dispenser may be re-stocked with the same product, which may be the most popular item to be dispensed. This may be changed on subsequent visits.

When the stock in such dispensers is being monitored, any changes to the stock items within dispensers needs to be notified to three potential places: —
Users—so that the user can obtain the desired stock item:
Machine electronics—so that the machine can vend at the correct price:
Central management system—so that it knows what stock it is monitoring.

Sometimes, the machine electronics does not need to know what stock is being dispensed—for example, where it needs to take no action—e.g. there is no charging or all products are vended at the same price.

To cater for the above requirements, the person re-stocking the machine will typically: —
Change the label on the front of the machine to inform the user;
Electronically configure the machine by switch settings or electronic interface to inform the new parameters e.g. new price; and
Centrally configure the monitoring application directly e.g. by using a web browser; or by making a telephone call for a central user operator to make the changes; or by making a log of the changes by paper or electronically for subsequent central configuration at a later time—e.g. end of day by PC interface.

FIG. 11 shows a vending machine 61 having a plurality of hoppers or stock containers 62 containing stock 63 (e.g. drinks) to be dispensed. Many methods of dispensing stock in a vending machine are known. The exact method of dispensing is not important to an understanding of the illustrated system and therefore will not be described in detail.

Labels 611 are provided on the front of the vending machine 61, one in front of each hopper or stock dispenser 62, to inform users what particular kind of stock 63 will be dispensed from each hopper or stock dispenser 62. Each of the labels 611 contains a poster compliance barcode feature that informs the vending machine electronics and central management application, over a remote link, which stock 63 has been loaded into which hopper or stock dispenser 62. That is, each label 611 is monitored in a similar manner to the posters or leaflets 511 in the system (5) of FIG. 10.

By implementing principles of the above-described poster compliance system (5), the modified vending machine system of FIG. 11 can achieve the following.
Meet the primary function of informing the user—e .g. the stock item is printed on the front of the label towards the user
The poster compliance barcode on the rear of the label can be detected by the machine—that is, the machine serves as the poster frame of system (5) and, by detecting the barcode, is able to make appropriate configuration changes automatically, without the need for subsequent configuration
The detected barcode can be monitored along with the stock items being monitored by the machine electronics to the central management application. This provides an automatic solution for configuring the management application and eliminates further configuration processes.

Such systems can be used in vending machines, as discussed above, as well as in other situations such as, for example, retail “dump bins” at end-of aisles, and with cigarettes or other stock loaded on intelligent shelving.

The system illustrated in FIG. 11 may interact with other subsidiary systems described and shown in this specification, to help identify stock and brands being monitored and thereby eliminate additional manual configuration stages for a more automated solution.

Although subsidiary systems are described above mainly in connection with the sale of goods, it will be appreciated that they may also be adapted to the sale of services, which are often bought in store locations at the present day.

Data processing systems comprising one of more subsidiary systems as described above may have various advantages and distinctions from prior proposals. Some of these are as follows.

Much prior art concerns in-store digital displays. In the majority of cases, these systems require the use of in-store PCs or servers to provide local management functions. Subsidiary systems as described may differentiate by eliminating the need for in-store dedicated management PCs and Servers. This is achieved through centralised management resources which manage many remote in-store systems using wide area communications such as GSM, GPRS, the Internet and broadband communication.

Thus, subsidiary systems as described need not be reliant upon a retailer's business and IT infrastructure, thereby enabling the subsidiary systems to be used by non-retailers such as brand owners, merchandisers and other stakeholders within the supply chain.

By eliminating the need for onsite management, display and monitoring technologies can utilise simple solutions that can be integrated within Point of Purchase display stands.

Generally, a consumer in subsidiary systems as described has no direct control over displayed information. Any monitored responses are gathered, analysed and processed as a group of consumers rather than an individual user, which only then may influence a change in the displayed information by the retailer, brand owner or other merchant.

There is preferably independence from the retailer's infrastructure and the ability for brand owners to remotely manage subsidiary systems outside of the retail store.

Subsidiary systems as described may both be integrated within standalone POP display stands and monitor responses to displayed content.

Subsidiary systems as described do not require explicit “interaction” with consumers to measure consumer response. Display, monitoring and communication elements may be separate items which are networked at various locations around a store.

Subsidiary systems as described may afford remote programmability of lighting levels from a central location. In particular, response stimuli for changing light levels need not be through direct local interaction with sensors or actuators. Light levels may be changed in response to indirect monitoring of consumer response via a central site. As an alternative, content display programmed from a central site may be temporarily re-configured as a result of detected consumer response, by displaying alternative content that has been previous configured from the central site.

Subsidiary systems as described may detect items placed on or taken off a POP display rather than indicating the presence of items to an external device. This may take the form of either detecting products such as newspapers, cigarettes, etc., or the presence of advertising material which has been encoded with an identifier such as a barcode which is used to check advertising and POP compliance.

In this specification, the verb “comprise” has its normal dictionary meaning, to denote non-exclusive inclusion. That is, use of the word “comprise” (or any of its derivatives) to include one feature or more, does not exclude the possibility of also including further features.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A data processing system comprising:
a central management system;
a store at a site that is remote from the location of the central management system;
communication means for providing data communication between said central management system and remote site;
display means at said remote site arranged to display content that imparts visible and/or audible information to store customers; and
monitoring means at said remote site arranged to monitor behaviour of store customers:
wherein said data processing system is arranged to transmit predetermined content data from said central management system to said remote site for display on said display means and to transmit from said remote site to said central management system monitored customer behaviour data, to enable evaluation at said central management system of said customer behaviour in response to said content data.

2. A data processing system according to claim 1, wherein said display means comprises a display for displaying visible content.

3. (canceled)

4. A data processing system according to claim 1, wherein said display means is located in the vicinity of a display of respective goods to which said content data received from said central management system relates.

5. A data processing system according to claim 4, wherein said display means is adjacent to or integrated with a Point Of Purchase (POP) display.

6. A data processing system according to claim 1, wherein said monitoring means is adapted to receive product purchase information at a payment terminal.

7. (canceled)

8. (canceled)

9. (canceled)

10. A data processing system according to claim 1, wherein said monitoring means is adapted to detect movement of stock on or from a display point.

11. A data processing system according to claim 1, wherein said monitoring means is adapted to detect change of weight of stock at a display point.

12. A data processing system according to claim 1, arranged to transmit said predetermined content data from said central management system to said remote site and to transmit said monitored customer behaviour data from said remote site to said central management system, without reliance upon existing in-store IT infrastructure at said remote site.

13. (canceled)

14. (canceled)

15. A data processing system according to claim 1, further comprising:
a Point Of Purchase (POP) display at said remote site; and
stock monitoring means at said remote site arranged to monitor the level of stock in said POP display:
wherein said data processing system is arranged to transmit stock level data monitored by said stock monitoring means to said central management system by said communication means.

16. A data processing system according to claim 15, wherein said stock monitoring means is adapted to detect movement of stock on said POP display.

17. A data processing system according to claim 15, wherein said stock monitoring means is adapted to detect change of weight of stock on said POP display.

18. A data processing system according to claim 15, further comprising means for detecting and transmitting to said central management system further data representing at least one of: the presence and/or movement of consumers in the vicinity of said POP display; ambient conditions in the vicinity of said POP display; and local promotion information in the vicinity of said POP display such as electronic displays and posters.

19. (canceled)

20. (canceled)

21. A data processing system according to claim 15, wherein said POP display is not adapted to take payment for products displayed or dispensed.

22. A data processing system according to claim 15, arranged to transmit said stock level data monitored by said stock monitoring means from said remote site to said central management system, without reliance upon existing in-store IT infrastructure at said remote site.

23-46. (canceled)

47. A method of data processing, comprising the steps of:
transmitting predetermined content data over a communication link from a central management system to a store at a site that is remote from the location of the central management system;
displaying at said remote site content derived from said content data, to impart visible and/or audible information to store customers;
monitoring behaviour of store customers means at said remote site; and
transmitting monitored customer behaviour data from said remote site to said central management system over said communication link, to enable evaluation at said central management system of said customer behaviour in response to said content data.

48. (canceled)

49. (canceled)

50. A method according to claim 47, further comprising the steps of:
monitoring the level of stock in a Point Of Purchase (POP) display at said remote site; and
transmitting stock level data monitored by said stock monitoring means to said central management system.

51-57. (canceled)

58. A data processing system according to claim 1, further comprising means for receiving data from devices at said remote site, which data represents parameters or conditions at said remote site that are not related directly to behaviour of store customers and is transmitted by the data processing system to said central management system.

59. A data processing system according to claim 58, wherein said means for receiving data from devices at said remote site, which data represents parameters or conditions at said remote site that are not related directly to behaviour of store customers, is arranged to receive data from at least one of the group comprising utility meters, heating devices, ventilation devices, air conditioning devices, refrigeration devices, security systems, access control devices, lighting systems, gaming machines, vending machines, beverage dispensers, EPOS systems, temperature sensors, humidity sensors, pressure sensors, weight sensors and position sensors.
